(19) United States
(12) Patent Application Publication
(10) Pub. No.: US 2026/0343676 A1
(43) Pub. Date: Oct. 29, 2026

(54) MBS MULTICAST CONFIGURATION

(71) Applicant: CANON KABUSHIKI KAISHA, Tokyo (JP)

(72) Inventors: Walaa SAHYOUN, RENNES (FR); Yacine EL KOLLI, RENNES (FR); Pierre VISA, RENNES (FR)

(21) Appl. No.: 18/998,971

(22) PCT Filed: Jul. 18, 2023
(86) PCT No.: PCT/EP2023/069960

§ 371 Date: Jan. 27, 2025

(30) Foreign Application Priority Data
Jul. 28, 2022 (GB) 2211067.0
Sep. 29, 2022 (GB) 2214308.5

(51) Int. Cl. H04W 76/40; H04W 68/02; H04W 76/20

(52) U.S. Cl. CPC H04W 76/40; H04W 68/02; H04W 76/20

(57) ABSTRACT

Methods and apparatus relating to providing MBS multicast data reception configuration parameters to a UE (User Equipment). A User Equipment, UE, of a wireless communication system, receives, for a multicast (MBS) session for which the UE has requested to join, multicast pre-configuration information for the multicast session, wherein the multicast pre-configuration information may be received prior to activation of the multicast session and/or after activation of the multicast session. The UE is configured according to the multicast (pre-) configuration information to receive multicast data via the multicast session. At a base station controlling a cell serving User Equipment, UE, establishment of a multicast session requested by a UE is performed.

### FIELD OF THE INVENTION

The present invention generally relates to providing MBS multicast data reception configuration parameters to a UE (User Equipment), and particularly, but not exclusively, to configuring a UE to receive the MBS multicast data when the UE is in either one of an RRC_CONNECTED or RRC_INACTIVE state.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g., video, voice, messaging . . . ) over a radio access network (RAN) through one or more base stations.

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as Wi-Fi.

Among the requirements for 5G NR, there are service requirements related to multicast and broadcast service, abbreviated as MBS.

For broadcast communication service, the same service and the same specific content data are provided simultaneously to all UEs in a geographical area (i.e., all UEs in the broadcast service area are authorized to receive the data). A broadcast communication service is delivered to the UEs using a broadcast session. For multicast communication service, the same service and the same specific content data are provided simultaneously to a dedicated set of UEs (i.e., not all UEs in the multicast service area are authorized to receive the data). A multicast communication service is delivered to the UEs using a multicast session.

The support of multicast/broadcast techniques enable the network to operate in a more efficient manner than unicast. The identified use cases that could benefit from this MBS feature include public safety and mission critical, V2X applications, IPTV, live video, software delivery over wireless and loT applications. 3GPP started to build functional support of MBS in 5G NR with Release 17.

In 5G NR, Radio Resource Control (RRC) protocol operates in the control plane between a UE and a base station (gNB), and provides 3 different states for a UE as defined in the 3GPP specifications TS 38.331: RRC_CONNECTED, RRC_INACTIVE, and RRC_IDLE states. At power up, a UE is in RRC_IDLE state, and the UE changes to RRC_CONNECTED state upon an RRC connection establishment with a gNB. If the RRC connection is released, then the UE changes back to RRC_IDLE state. When in RRC_CONNECTED state, the RRC connection can be suspended by the gNB, and the UE moves to RRC_INACTIVE state. When the UE is in RRC_INACTIVE state it cannot communicate with the 5G system, but both the gNB and the UE keep track of the RRC connection context. Thus, the transition back to the RRC_CONNECTED state from the RRC_INACTIVE state is faster than the RRC connection establishment from RRC_IDLE to RRC_CONNECTED state.

With the 3GPP Release 17, the reception of MBS broadcast by a UE is allowed when the UE is in RRC_IDLE, RRC_INACTIVE, or RRC_CONNECTED state, and the reception of MBS multicast is allowed when the UE is in RRC_CONNECTED state only. For the Release 18, the plan is to further allow the MBS multicast reception when the UE is in RRC_INACTIVE state. See, for example, 3GPP RP-213568 entitled “New WID: Enhancements of NR Multicast and Broadcast Services” submitted by CATT and entitled (3GPP TSG RAN Meeting #94-e, source CATT), section 3. The objective is to enable a large density of UEs to be receiving multicast data from one cell. Indeed, having UEs in RRC_INACTIVE state leads to a downsize in the control plane footprint of the overall UEs, and thus allows the gNB to handle more UEs. Besides, to always keep UEs in RRC_CONNECTED state is not power efficient. As a result, the advantages of also supporting multicast for UEs in RRC_INACTIVE state have been recognized.

In Release 17, the MBS multicast session follows state transitions as defined in 3GPP TS 23.247 v17.3.0, FIGS. 4.3-1. The 5G nodes involved in MBS session management are described in clause 5.1 “General Architecture” of TS 23.247 v17.3.0. In this document “session” always refers to “MBS session”.

The session management procedures include session creation (7.1.1.2 or 7.1.1.3 of TS 23.247), session activation (7.2.5.2 of TS 23.247), session establishment and join (7.2.1.3 of TS 23.247).

At start the session does not exist. The session is created on demand of the AF (Application Function). As part of the creation process, the MBS session identifier is allocated, a multicast service area is defined and the session is announced to UEs in the service area. The multicast service area is defined in 3GPP TS 22. 146 version 17.0.0, clause 3 “Definitions”. The multicast service area is defined per multicast service. One multicast service can start multiple multicast sessions. A multicast service area can be as big as a PLMN (Public Land Mobile Network) coverage area or less.

Once the session is created, the first UE to send a join request to that session will trigger the session establishment toward the NG-RAN (gNB(s) included in the multicast service area). Subsequent join request from other UEs will not trigger the session establishment. The session establishment procedure includes PDU (Protocol Data Unit) session establishment by the UE, session join request by the UE (associating the PDU session to the MBS session), resources reservation from the core to the NG-RAN for the delivery of MBS data for the first join request.

Also, once the session is created, the MB-SMF (MBS Session Management Function) can be triggered to activate the session. The trigger condition reflects the availability of the multicast data from the application. The session activation procedure includes NG-RAN resource reservation.

It is only when both the session is activated and the MBS session is established that the NG-RAN will configure the UE for the reception of multicast data.

The launch of the processes of session activation and session establishment answers to different triggers: for session activation, the trigger is the availability of the multicast data from the application and for session establishment, the trigger is the presence of at least one UE in the service area that sends a join request to the multicast session.

The establishment of an MBS session in a UE is performed when the UE is in RRC_CONNECTED state. It is possible that a gNB may then decide to switch the UE to RRC_INACTIVE state before the MBS multicast data is available through the session activation. As a result, when the session is activated the NG-RAN (at least one gNB) will have to notify and configure the UEs that have joined the session but are in RRC_INACTIVE state.

The current version of the specifications does not provide a procedure to notify or configure a UE in RRC_INACTIVE state. UE in RRC_INNACTIVE state is not supposed to receive any data from applications and have limited access to control plane.

In Release 17, some mechanism was proposed to handle the case of broadcast reception in RRC_INACTIVE state. Document TS 38.300 version 17.0.0, in clause 16.10.6.2 explains the use of MCCH (MBS Control Channel) by the gNB to provide the configuration to UEs in any RCC state including the RRC_INACTIVE state. Indeed, the MCCH channel is accessible to UEs RRC_INACTIVE state and it is well adapted to send notifications and configuration parameters. However, the MCCH is indeed accessible to all UEs without restriction which for MBS multicast services represents a security breach since the access to the multicast data is subject to prior authorization for each UE during the join procedure. The multicast configuration should be available only to UEs who have acquired the proper authorization during the join procedure. Furthermore, the MCCH content may need to be transmitted periodically and thus, it is not efficient in terms of bandwidth.

As part of on-going discussions for Release 18, document S2-2200599 proposes to switch the UE back into the RRC_CONNECTED state, perform the configuration and switch again the UE to RRC_INACTIVE state. While this solution seems functional, the purpose of offloading the gNB in case of large density of UEs by having UEs in the RRC_INACTIVE state may not be achieved due to the additional signalling and other resources required to switch to the RRC_CONNECTED state in order to configure the UE and then switch back again to the RRC_INACTIVE state.

Accordingly, it is desirable to provide at least one solution to enable a UE, which has previously joined a multicast session, to be configured to receive multicast data when the multicast session is activated whilst staying in RRC_INACTIVE state.

### SUMMARY OF THE INVENTION

According to an aspect of the invention there is provided a multicast pre-configuration information for the multicast session, wherein the multicast pre-configuration information is received prior to activation of the multicast session, and configuring the UE according to the multicast pre-configuration information to receive multicast data via the multicast session. The method may comprise sending a request to join a multicast session to a core network via a base station. The multicast pre-configuration information may be received from a base station.

The multicast pre-configuration information may be included in at least one of a Radio Resource Control, RRC, message and a system information block, SIB. The pre-configuration information may include at least one of:
radio bearer configuration information associated with low quality of service, QoS, transmission,
radio bearer configuration information associated with high quality of service, QoS, transmission,
discontinuous reception, DRX, configuration information, and
neighbour cell multicast configuration information.

The pre-configuration information comprising radio bearer configuration information associated with low quality of service, QoS, transmission, may be for configuring the UE when it is operating in a non-connected (RRC) state. The pre-configuration information comprising radio bearer configuration information associated with high quality of service, QoS, transmission, may be for configuring the UE when it is in a connected RRC state.

The multicast pre-configuration information may comprise an update of existing configuration information for receiving multicast data via the multicast session, and the configuring may comprise using the pre-configuration information to update the configuration of the UE to receive the multicast data via the multicast session.

The method may further comprise receiving data for the multicast session after performing the configuration according to the multicast pre-configuration information.

The multicast pre-configuration information may be received upon or after establishment of the multicast session.

The multicast pre-configuration information may be received in a message for causing the UE to be put in a non-connected RRC state. A non-connected RRC state may be an RRC_INACTIVE state.

The multicast pre-configuration information may be received with (e.g., together with or as part of) an RRC release message.

The multicast pre-configuration information may be received while the UE is operating in a non-connected RRC state.

The multicast pre-configuration information may be received after a cell re-selection process which causes the UE to camp in a base station.

The method may comprise, after the cell re-selection process, receiving a notification indicating multicast pre-configuration is available for the multicast session; and
sending, by the UE, a multicast pre-configuration request to the base station, wherein the multicast pre-configuration information is received from the base station in response to the sent request.

The multicast-pre-configuration request may be sent after performing a physical random access channel, PRACH, procedure performed with the base station in response to the notification indicating the multicast pre-configuration information is available.

The cell re-selection process comprises sending information from the UE to a base station in a case where a new cell has been selected as a result of the cell re-selection process. The method may comprise sending a target base station identifier to the base station, the target base station identifier identifying a target base station associated with the new cell. Additionally, or alternatively, the method may comprise sending to a target base station associated with the new cell, multicast session identification information for identifying one or more multicast sessions joined by the UE.

The method may further comprise receiving a notification of activation of the multicast session after receiving the multicast pre-configuration information.

The UE may be configured according to the multicast pre-configuration information in response to receiving the notification.

The notification of activation may be any one of a paging message, an RRC message and a system information block, SIB.

The UE may be operating in a non-connected RRC state when receiving a notification of activation of the multicast session, and the notification of activation is received after a cell re-selection process which causes the UE to camp in a base station.

A request may be sent for multicast reception and/or multicast feedback information after receiving multicast data, and, in response, further multicast configuration data may be received at the UE.

The cell re-selection process may comprise sending information from the UE to the base station that indicates multicast session identification information of multicast sessions joined by the UE.

In a further aspect according to the present invention, there is provided a method at a base station controlling a cell serving User Equipment, UE, the method comprising performing establishment of a multicast session requested by a UE, and sending, to the UE, multicast pre-configuration information for the multicast session prior to activation of the multicast session.

The base station may receive a request to join the multicast session from the UE and send the request to join the multicast session to a core network. The base station may receive from the core network information for establishing the multicast session. Establishment of the multicast session may be between the UE, the base station and a core network.

The multicast pre-configuration information may be included in at least one of a Radio Resource Control, RRC, message and a system information block, SIB.

The pre-configuration information may include one or more of:
radio bearer configuration information dedicated for low quality of service, QoS, transmission,
radio bearer configuration information dedicated for high quality of service, QoS, transmission,
discontinuous reception, DRX, configuration information, and
neighbour cell multicast configuration information.

The pre-configuration information comprising radio bearer configuration information associated with low quality of service, QoS, transmission, may be for configuring a UE when it is operating in a non-connected RRC state. The pre-configuration information comprising radio bearer configuration information associated with high quality of service, QoS, transmission, may be for configuring a UE when it is in a connected RRC state.

The multicast pre-configuration information may include an update of existing configuration information for receiving multicast data via the multicast session.

The method may comprise sending data for the multicast session to the UE, according to the multicast pre-configuration information.

The multicast pre-configuration information may be sent upon or after establishment of the multicast session.

The multicast pre-configuration information may be sent to the UE in a message for causing the UE to being put in a non-connected RRC state.

The multicast pre-configuration information may be sent with (together with or as part of) an RRC release message.

The multicast pre-configuration information may be sent to the UE when the UE is operating in a non-connected RRC state.

The multicast pre-configuration information may be sent after a cell re-selection process which causes the UE to camp in a base station.

After the cell re-selection process, a notification may be sent indicating multicast pre-configuration; and a multicast pre-configuration request may be received from the UE, wherein the multicast pre-configuration data is sent in response to receiving the request.

The multicast pre-configuration request may be received after performing a physical random access channel, PRACH, process with the UE.

The cell re-selection process may comprise sending information from the UE to a base station in a case where a new cell has been selected as a result of the cell re-selection process.

The method may comprise receiving, as a source base station, a target base station identifier identifying a target base station associated with the new cell. The method may alternatively or additionally comprise receiving, as a target base station associated with the new cell, multicast session identification information for identifying one or more multicast sessions joined by the UE, that indicates multicast session identification information of multicast sessions joined by the UE.

A notification of the activation of the multicast session may be sent to the UE.

The notification of activation may comprise at least one of a paging message, an RRC message and an SIB.

Optionally, the UE is operating a non-connected RRC state when the notification of activation of the multicast session is sent and the notification of activation is sent by the base station to the UE after a cell re-selection process which causes the UE to camp in a base station.

The method may further comprise receiving, from the UE, a request for multicast reception and/or multicast feedback information after sending multicast data to the UE, and sending, in response, further multicast configuration data for the multicast session to the UE.

The cell re-selection process may comprise sending information from the UE to base station that indicates multicast session identification information of one or more multicast sessions joined by the UE.

According to another aspect of the invention there is provided a method at a User Equipment, UE, of a wireless communication system, the method comprising receiving, for a multicast session for which the UE has requested to join, multicast pre-configuration information for the multicast session; and configuring the UE according to the multicast pre-configuration information to receive multicast data via the multicast session.

The multicast pre-configuration information may be configuration information (data) that is received and stored, to be applied later in an appropriate (or predetermined) situation. For example, according to one or more embodiments it is received before multicast (MBS) session activation of the session to which the pre-configuration information relates. Alternatively, or additionally, a UE may receive multicast data after multicast (MBS) session activation, and the network provides pre-configuration data to pre-configure the UE to receive multicast data after cell switching as a result of a cell re-selection process. Depending on the implementation, it can be used to configure the UE before and/or after the multicast (MBS) session activation.

The method may include sending a request to join a multicast session to a core network via a base station.

The multicast pre-configuration information may be received from a base station (e.g., a gNB or NG-RAN node).

The multicast pre-configuration information may be included in at least one of a Radio Resource Control, RRC, message, a system information block, SIB, and an MBS Control Channel (MCCH) message.

According to one or more embodiments, the pre-configuration information includes at least one of:
radio bearer configuration information associated with low quality of service, QoS, transmission (e.g., Multicast Radio Bearer “MRB2” configuration dedicated to receiving multicast data with low QoS for candidate UEs),
radio bearer configuration information associated with high quality of service, QoS, transmission (e.g., Multcast Radio Bearer “MRB1” configuration mainly addressed for UEs in RRC_CONNECTED state with high QoS),
an inactive reception indicator that indicates to a UE if it is enabled to receive multicast data in a non-connected RRC state (e.g., an RRC_INACTIVE reception indication where the gNB indicates to the UEs if they are enabled to receive multicast data in RRC_INACTIVE state),
information identifying a group of UEs within the same cell interested in receiving multicast data (e.g., G-RNTI identifying a group of UEs within the same cell interested in receiving multicast data),
a multicast pre-configuration ID identifying a configuration applied by UEs and associated with a multicast (MBS) session ID (e.g., a Temporary Mobile Group Identity, TMGI),
discontinuous reception, DRX, configuration information,
neighbour cell multicast configuration information (e.g., applied when candidate UEs perform handover or cell re-selection), and
cell identification information for identifying one or more cells for which the pre-configuration shall be applied (e.g., Cell ID(s)).

The multicast pre-configuration information may comprise an update of existing configuration information for receiving multicast data via the multicast session, and the configuring may comprise using the pre-configuration information to update the configuration of the UE to receive the multicast data via the multicast session.

The method may further comprise receiving data for the multicast session after performing the configuration according to the multicast pre-configuration information.

The multicast pre-configuration information may be received prior to activation of the multicast session.

The multicast pre-configuration information may be received upon or after establishment of the multicast session.

A notification of activation of the multicast session may be received after receiving the multicast pre-configuration information.

The UE may be configured according to the multicast pre-configuration information in response to receiving the notification.

The notification of activation may be any one of a paging message, an RRC message, a system information block, SIB, and an MBS Control Chanel (MCCH) message.

The UE may be operating in a non-connected RRC state (e.g., an RRC_INACTIVE state) when receiving a notification of activation of the multicast session. The notification of activation may be received after a cell re-selection process which causes the UE to camp in a base station.

A request for multicast reception and/or multicast feedback information may be sent after receiving multicast data, and receiving, in response, further multicast configuration data at the UE.

The cell re-selection process may comprise sending information from the UE to base station that indicates multicast session identification information of one or more multicast sessions joined by the UE.

The multicast pre-configuration information may be received after the activation of the multicast session.

The multicast pre-configuration information may be received in a message for causing the UE to be put in a non-connected RRC state (e.g., an RRC_INACTIVE state).

The multicast pre-configuration information may be received in an RRC release message (e.g., an RRC Release with SuspendConfig message).

The multicast pre-configuration information may be received while the UE is operating in a non-connected RRC state (e.g., an RRC_INACTIVE state).

The multicast pre-configuration information may be received after a determination that a modification of the multicast configuration is required. For example, after a cell re-selection process which causes the UE to camp in a base station (e.g., a different base station to that which the UE had previously established its configuration with the multicast session). Additionally, or alternatively, the base station may be controlling a cell in which the UE was already camped, but a configuration update of the base station may have caused a modification of the multicast configuration.

The method may further comprise:
after the cell re-selection process, receiving a notification indicating multicast pre-configuration is available for the multicast session; and
sending, by the UE, a multicast pre-configuration request to the base station, wherein the multicast pre-configuration information is received from the base station in response to the sent request.

The multicast pre-configuration request may be sent after performing a physical random access channel, PRACH, procedure with the base station in response to the notification indicating the multicast pre-configuration information is available.

The cell re-selection process may comprise sending information from the UE to a base station in a case where a new cell has been selected as a result of the cell re-selection process.

The method may comprise sending a target base station identifier to the base station, the target base station identifier identifying a target base station associated with the new cell.

The method may comprise sending to a target base station associated with the new cell, multicast session identification information for identifying one or more multicast sessions joined by the UE.

The method may further comprise, while the UE is operating in a non-connected RRC state:
prior to the cell re-selection process, receiving multicast data for an active multicast session according to a configuration for a base station in which the UE is camped before cell re-selection, and
wherein the pre-configuration information is for configuring the UE to receive multicast data from the multicast session from the base station in which the UE is to be camped following cell-re-selection.

The cell re-selection process may comprise detecting by the UE if the cell is in the multicast service area for which the UE does not have a corresponding multicast configuration.

The request for the multicast pre-configuration information may comprise at least one of G-RNTI information and multicast session identification information, wherein said G-RNTI information is used by the UE to decode the received multicast data.

According to a further aspect of the invention there is provided a method at a base station (e.g., a gNB or NG-RAN node) controlling a cell serving User Equipment, UE, the method comprising performing establishment of a multicast session requested by a UE; and sending, to the UE, multicast pre-configuration information for the multicast session.

The method may comprise receiving a request to join the multicast session from the UE and sending the request to join the multicast session to a core network.

The multicast session may be established between the UE, the base station (NG-RAN node) and a core network (e.g., 5G core network).

The multicast pre-configuration information may be included in at least one of a Radio Resource Control, RRC, message and a system information block, SIB.

The pre-configuration information may include one or more of:
radio bearer configuration information dedicated for low quality of service, QoS, transmission (e.g., Multicast Radio Bearer “MRB2” configuration dedicated to receiving multicast data with low QoS for candidate UEs),
radio bearer configuration information dedicated for high quality of service, QoS, transmission (e.g., Multicast Radio Bearer “MRB1” configuration mainly addressed for UEs in RRC_CONNECTED state with high QoS),
an inactive reception indication that indicates to a UE(s) if they are enabled to receive multicast data in a non-connected RRC state (e.g., an RRC_INACTIVE reception indication where the gNB indicates to the UEs if they are enabled to receive multicast data in RRC_INACTIVE state),
information identifying a group of UEs within the same cell interested in receiving multicast data (e.g., an RRC_INACTIVE reception indication where the gNB indicates to the UEs if they are enabled to receive multicast data in RRC_INACTIVE state),
a multicast pre-configuration ID identifying a configuration applied by UEs and associated with a multicast session ID (e.g., a Temporary Mobile Group Identity, TMGI),
discontinuous reception, DRX, configuration information,
neighbour cell multicast configuration information (e.g., applied when candidate UEs perform handover or cell re-selection), and
cell identification information for identifying one or more cells for which the pre-configuration shall be applied (e.g., Cell ID(s)).

The multicast pre-configuration information may include an update of existing configuration information for receiving multicast data via the multicast session.

The method may further comprise sending data for the multicast session to the UE, according to the multicast pre-configuration information.

The multicast pre-configuration information may be sent prior to activation of the multicast session.

The multicast pre-configuration information may be sent upon or after establishment of the multicast session.

The method may further comprise sending a notification of the activation of the multicast session to the UE.

The notification of activation may comprise at least one of a paging message, an RRC message and an SIB.

In one or more embodiments, the UE is operating in a non-connected RRC state (e.g., RRC_INACTIVE state) when the notification of activation of the multicast session is sent, and the notification of activation is sent by the base station to the UE after a cell re-selection process.

The method may further comprise receiving from the UE, a request for multicast reception and/or multicast feedback information after sending multicast data to the UE, and sending, in response, further multicast configuration data for the multicast session to the UE.

The cell re-selection process may comprise sending information from the UE to base station that indicates multicast session identification information of one or more multicast sessions joined by the UE.

In one or more embodiments the multicast pre-configuration information is sent after the activation of the multicast session.

The multicast pre-configuration information may be sent to the UE in a message for causing the UE to be put in a non-connected RRC state (e.g., RRC_INACTIVE state).

The multicast pre-configuration information may be sent in an RRC release message.

The multicast pre-configuration information may be sent to the UE when the UE is operating in a non-connected RRC state.

The multicast pre-configuration information may be sent after a cell re-selection process which causes the UE to camp in a base station.

The method may further comprise:
after the cell re-selection process, sending a notification indicating multicast pre-configuration information is available for the multicast session; and
receiving, from the UE, a multicast pre-configuration request, wherein the multicast pre-configuration information is sent in response to receiving the request.

The multicast pre-configuration request may be received after performing a physical random-access channel, PRACH, process with the UE.

The cell re-selection process may comprise receiving information from the UE at a base station in a case where a new cell has been selected as a result of the cell re-selection process.

The method may comprise receiving, as a source base station, a target base station identifier identifying a target base station associated with the new cell.

The method may comprise receiving, as a target base station associated with the new cell, multicast session identification information for identifying one or more multicast sessions joined by the UE.

The UE may be configured in a non-connected RRC state (e.g., RRC_INACTIVE state). The base station may be controlling a cell in which it is determined that a modification of the multicast configuration is required. For example, the base station may be controlling a cell in which the UE is to be camped following a cell re-selection process (e.g., a different base station to that which the UE had previously established its configuration with the multicast session). Alternatively, the base station may be controlling a cell in which the UE was already camped, but a configuration update of the base station may have caused a modification of the multicast configuration. The method may further comprise receiving a request, from the UE, for multicast pre-configuration information corresponding to the base station.

The method may further comprise sending, to the UE, a notification that multicast pre-configuration information is available.

According to one or more embodiments, the notification is sent if the base station detects that a modification of the multicast configuration is necessary for the UE to receive multicast data in the one or more cells it controls,

According to one or more embodiments, the notification is sent if the base station has been notified of a modification of the multicast configuration in one or more cells controlled by another base station.

The method may further comprise, before sending the updated multicast configuration information for the multicast session, checking that the UE has a context that allows it to receive multicast data for the multicast session.

In a yet further aspect according to the present invention, there is provided a method at a User Equipment, UE, (e.g., at least one UE) of a wireless communication system. The UE is configured to receive multicast data of an activated multicast session (i.e., a multicast session which has already been activated). The method comprises: sending a request to a base station for updated (e.g., new) multicast configuration information for the activated multicast session (i.e., the updated multicast configuration information may be configured for replacing any existing (e.g., initial or old) multicast configuration information which the UE may have obtained previously); receiving the updated multicast configuration information from the base station; and configuring the UE according to the updated multicast configuration information to receive multicast data of the activated multicast session.

The method may comprise sending the request to the base station in response to a determination that a modification of the multicast configuration of the UE is necessary for receiving (e.g., continuing to receive) multicast data of the activated multicast session. Prior to the determination of the requirement for the multicast configuration modification, the UE may have already received multicast configuration information corresponding to the activated multicast session. In situations where the previously received multicast configuration information is no longer valid for receiving data of the session, the method according to the present aspect advantageously re-configures the UE with updated multicast configuration information such that the UE can continue to receive multicast data of the activated multicast session.

The previous (e.g., initial) multicast configuration information of the UE may be obtained before or after the MBS session activation (establishment), for example, according to the methods described in the relevant aspects described herein. Optionally, the previous multicast configuration information may be obtained before the MBS session activation when the UE is in a non-connected RRC (e.g., RRC_INACTIVE) state or when the UE is in an RRC_CONNECTED state.

Alternatively, the previous multicast configuration information of the UE may be obtained after the MBS session activation when the UE is in a non-connected RRC (e.g., RRC_INACTIVE) state.

The method may comprise determining by the UE that updated multicast configuration information is necessary to receive multicast data of the activated multicast session. Advantageously, the UE may determine the requirement for updated multicast configuration information before sending the request to the base station.

The UE may determine that a modification of the multicast configuration is necessary (e.g., the method may comprise detecting, by the UE, the requirement for modification of the multicast modification).

The UE may be configured in a non-connected RRC state (e.g., when the request is sent to the base station). Optionally, the UE determines that the UE, when in a non-connected RRC (e.g., RRC_INACTIVE) state does not have the updated multicast configuration to receive multicast data (e.g., from the base station) for the activated multicast session.

The method may comprise sending the request to the base station in response to a re-selection process. The re-selection process may comprise the UE camping in a cell that is controlled by the base station (e.g., as described herein). For example, the UE may have initiated a handover or re-selection to the base station when configured in a non-connected RRC state).

The method may comprise sending the request to the base station in response to a configuration update of the base station (e.g., the modification of the multicast configuration may be caused by the base station configuration update). The configuration update may comprise a resetting of the base station, for example due to an error in the network and/or base station.

The method may comprise receiving, at the UE, a notification that updated multicast configuration information is available. The notification may be received from the base station. The request for updated multicast configuration information may be sent in response to the notification indicating that updated multicast configuration information is available.

The updated multicast configuration request may be sent after performing a physical random-access channel, PRACH, procedure with the base station.

Optionally, before sending the request for updated multicast configuration information (e.g., before a determination that the multicast configuration modification is required), the UE had previously obtained (e.g., initial or previous) multicast configuration information which does not allow (e.g., no longer enables) the UE to receive multicast data for the activated multicast session (e.g., from the base station).

Throughout the method of the present aspect, the UE can remain in a non-connected state, whilst continuing to receive multicast data from the activated multicast session.

In a yet further aspect according to the present invention, there is provided a method at a User Equipment, UE, (e.g., at least one UE) of a wireless communication system. The UE is configured to receive multicast data of an activated multicast session (i.e., a multicast session which has already been activated), wherein a modification of a multicast configuration of the UE is necessary (e.g., because the multicast configuration information that the UE had previously obtained for receiving multicast data of the activated multicast session is not (e.g., no longer) valid for receiving multicast data from the base station). The method comprises: sending a request to a base station for multicast configuration information for the activated multicast session; receiving multicast configuration information corresponding to the base station; and configuring the UE according to the multicast configuration information to receive multicast data of the activated multicast session. Further optional statements of the preceding aspect also apply to this aspect.

In a yet further aspect according to the present invention, there is provided method at a base station controlling a cell. The base station is configured to serve a User Equipment, UE (e.g., at least one UE), with multicast data of an activated multicast session (i.e., a multicast session which has already been activated). The method comprises: receiving a request, from the UE, for updated multicast configuration information of the activated multicast session (i.e., the updated multicast configuration information may be configured for replacing any existing (e.g., initial or old) multicast configuration information which the UE may have obtained previously); and sending, to the UE, updated multicast configuration information of the activated multicast session.

The previous (e.g., initial) multicast configuration information of the UE may have been obtained before or after the MBS session activation, for example, according to the methods described in any one of the relevant aspects described herein. Optionally, the previous multicast configuration information may have been acquired before the MBS session activation whilst the UE was in a non-connected RRC (e.g., RRC_INACTIVE) state or when the UE was in an RRC_CONNECTED state. Alternatively, the previous multicast configuration information may have been obtained after the MBS session activation when the UE is in a non-connected RRC (e.g., RRC_INACTIVE) state.

The method may comprise receiving the request from the UE after a determination that a modification of the multicast configuration of the UE is necessary for receiving (e.g., continuing to receive) multicast data of the activated multicast session. Prior to the determination of the requirement for the multicast configuration modification, the UE may have already received multicast configuration information corresponding to the activated multicast session. In situations where the previously received multicast configuration information is no longer valid, the method according to the present aspect advantageously provides updated multicast configuration information to the UE, which thereby enables the UE to continue receiving multicast data of the activated multicast session whilst remaining in a non-connected state.

Optionally, the method comprises, before receiving the request for updated multicast configuration information from the UE, determining by the base station that the updated multicast configuration information is necessary for the UE to receive multicast data of the activated multicast session. In this way, the base station may detect that the modification of the multicast configuration is required (e.g., the method, at the base station, may comprise detecting the necessity for modification (e.g., updating) of the multicast modification).

The UE may be configured in a non-connected RRC state (e.g., when the request is received by the base station). The method may comprise the base station determining that the UE in a non-connected RRC state does not have the updated multicast configuration necessary for receiving multicast data of the activated multicast session.

Optionally, the method comprises receiving the request from the UE following a re-selection process, which causes the UE to camp in a cell that is controlled by the base station. The re-selection process may comprise the UE camping in a cell that is controlled by the base station (e.g., as described herein). For example, the UE may have initiated a handover or re-selection to the base station when configured in a non-connected RRC state). Any multicast configuration information that has previously been transmitted by the base station may not have been received by the UE which is now camped in the cell controlled by the base station.

The method may comprise receiving the request from the UE following a configuration update of the base station. In this way, the modification of the multicast configuration may have been caused by the configuration update of the base station. For example, before the configuration update the base station may have transmitted multicast configuration information to the UE to enable the UE to receive multicast data for the multicast session. However, since the modification of the UE's multicast configuration, the previously transmitted multicast configuration information no longer allows the UE to receive multicast data of the activated session.

The method may further comprise the base station sending, to the UE, a notification that updated multicast configuration information is available. The notification may be any one of a paging message, an RRC message, a system information block, SIB, and an MBS Control Chanel (MCCH) message.

The multicast configuration request may be sent after performing a physical random-access channel, PRACH, procedure with the UE.

Throughout the method of the present aspect, the UE can remain in a non-connected state, whilst continuing to receive multicast data from the activated multicast session.

In a yet further aspect according to the present invention, there is provided a method at a base station controlling a cell serving User Equipment, UE (e.g., at least one UE). The base station is arranged for serving the UE with multicast data of an activated multicast session (i.e., a multicast session which has already been activated), wherein modification of a multicast configuration obtained by the UE is required (e.g., a multicast configuration which the UE had previously obtained for receiving multicast data of the activated multicast session is no longer valid). The method comprises: receiving a request, from the UE for (updated) multicast configuration information for the activated multicast session; and sending, to the UE, (updated) multicast configuration information corresponding to the base station. Further optional statements of the preceding aspect also apply to this aspect.

In a yet further aspect according to the present invention, there is provided a device comprising user equipment configured to perform a method according to any of the method aspects outlined above in respect of methods performed by UE.

In yet another aspect according to the present invention, there is provided a device comprising a base station configured to perform a method according to any of the method aspects set out above in respect of methods performed by a base station.

There is also provided a (computer) program comprising instructions which, when the program is executed by a computer, cause the computer to carry out a method according to any of the method aspects mentioned above.

The program may be provided on its own or may be carried on, by or in a (computer-readable) carrier medium. The carrier medium may be non-transitory, for example a storage medium, in particular a computer-readable storage medium. The carrier medium may also be transitory, for example a signal or other transmission medium. The signal may be transmitted via any suitable network, including the Internet. Further features of the invention are characterised by the independent and dependent claims.

In any of the above aspects a multicast session may comprise a session where data is sent from a network to one or more UEs, the participating UEs having specified properties or a particular profile/configuration that qualifies them to receive data via the multicast session. The multicast session may be a multicast and broadcast, MBS, session according to fifth generation (5G) new radio (NR), for example as defined in Release 17 of 5G NR.

Any feature in one aspect of the invention may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram illustrating a first example wireless communication system in which the present invention may be implemented according to one or more embodiments;

FIG. 2 illustrates a block schematic diagram of an example configuration of a UE in which the present invention may be implemented according to one or more embodiments;

FIG. 3 illustrates a block schematic diagram of an example configuration of a base station in which the present invention may be implemented according to one or more embodiments;

FIG. 4 is a flowchart showing the RRC connection states and transitions for a UE in 5G NR systems;

FIG. 5 is a simplified flowchart illustrating MBS session evolution from creation to activation;

FIG. 6 is a flowchart illustrating the sending of UE pre-configuration after join request according to an embodiment;

FIG. 7 is a flowchart illustrating the sending of UE pre-configuration after handover according to an embodiment;

FIG. 8 is a flowchart illustrating the sending of UE pre-configuration as part of RRC_Release procedure according to an embodiment;

FIG. 9 is a flowchart illustrating the sending of UE pre-configuration triggered by a paging message;

FIGS. 10a and 10b are flowcharts illustrating the sending of UE pre-configuration as result of a special cell re-selection process according to an embodiment;

FIG. 11 is a flowchart illustrating the use of the pre-configuration by the UE after the session is activated according to an embodiment;

FIG. 12 is a flowchart illustrating the use of the pre-configuration by the UE after the session is activated according to an embodiment;

FIG. 13 is a flow chart of a method executed by the gNB according to an embodiment;

FIG. 14 is a flow chart of a method executed by the UE according to an embodiment;

FIG. 15 is a flow chart showing a process whereby pre-configuration information is received at a UE according to an embodiment; and

FIG. 16 is a flow chart showing a process whereby pre-configuration information is sent by a base station according to an embodiment.

FIG. 17 is a flow chart showing the update of a multicast configuration is initiated by the network for UEs in an RRC_INACTIVE state according to an embodiment;

FIG. 18 is a flow chart showing the sending of a configuration update request by a UE in an RRC_INACTIVE state according to an embodiment;

FIG. 19 is a flow chart showing a method of controlling a UE in an RRC_INACTIVE state to update a multicast configuration of the UE, according to an embodiment; and

FIG. 20 is a flow chart showing a method of controlling a base station to update a multicast configuration of a UE in an RRC_INACTIVE state, according to an embodiment.

### DETAILED DESCRIPTION

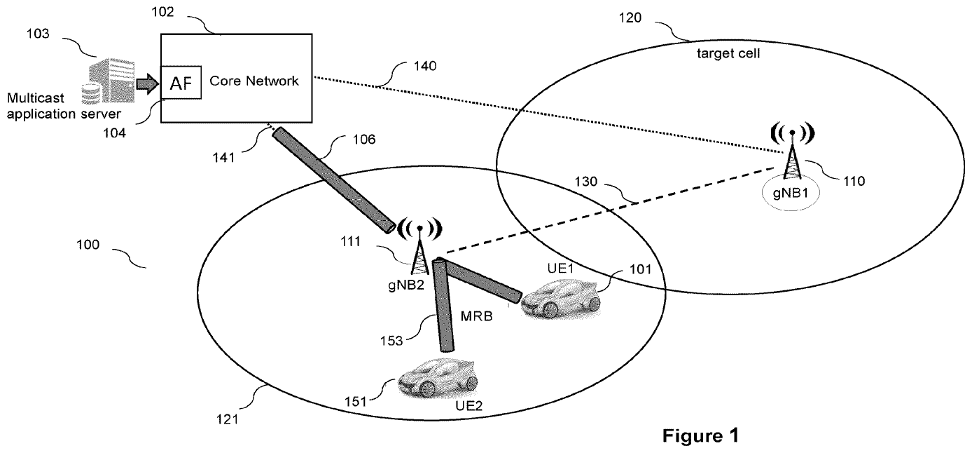

FIG. 1 illustrates an example wireless communication system 100, in particular a mobile radio communication system such as a fifth-generation (5G) New Radio (NR) system supporting multicast and broadcast service (MBS). Although in the following description, embodiments and examples of embodiments of the present invention will be described with respect to a 5G NR system, it will be appreciated that it is not intended that the present invention is limited to 5G NR systems and may be used in any wireless communication systems supporting MBS or similar service.

The system 100 comprises a User Equipment (UE) 101 (or 151), which may be for instance in or part of a vehicle, served by a base station 110 to communicate with a core network, such as the 5G core network 102. The UE may be any wireless device, such as a wireless communication device or apparatus or terminal, IoT device, Machine Type Communication (MTC) device, Device to Device (D2D) terminal, user device (e.g., smart phone, laptop, mobile phone, tablet, camera, game console, wearable device), capable of wireless communication with one or more core networks via one or more Radio Access Networks. The base station 110 is a network node which provides an access point to the core network for a UE and is part of the Radio Access Network (RAN) composed of the base stations 110, and 111. In NR, base stations are referred to as next-generation Node Bs (gNBs), the RAN is a Next Generation (NG) RAN and the core network is referred to as the 5GC. In the following, the terms RAN node, base station and gNB will be used interchangeably. The base stations 110 and 111 are interconnected by means of the Xn interface (specified in the 3GPP document TS 38.423) implemented on the wired or wireless link 130. Each base station is connected to the core network 102 by means of the NG interface (specified in the 3GPP document TS 38.413) implemented on the wired or wireless links 140 and 141.

Each of these base stations controls one or multiple cells. For instance, the base station 110 controls the cell 120, and the base station 111 controls the cell 121. A cell is a geographical area of a radio network defined by the frequency used in the cell to transmit data. The cell can be uniquely identified by a UE from an identification that is broadcasted over a geographical area. Each base station 110, 111 can serve several UEs like the UE 101 or UE 151. Once a UE has established a RRC connection with a base station (as discussed below), the base station, to which the UE is connected, is referred to as the serving base station or source base station of the UE and the cell which is controlled by the serving base station, and on which the UE camps, is referred to as the serving cell. The interface between a gNB and a UE is the Uu interface using the protocol sublayers SDAP (Service Data Adaptation Protocol), PDCP (Packet Data Convergence Protocol), RLC (Radio Link Control), MAC (Medium Access Control), PHY (Physical) in the user plane, and the protocol sublayers RRC (Radio Resource Control), PDCP, RLC, MAC, PHY in the control plane.

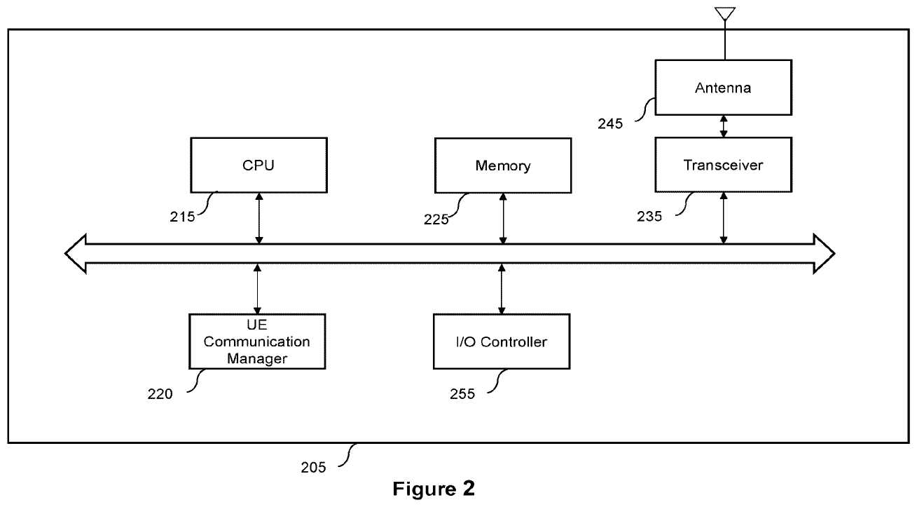

FIG. 2 illustrates a block diagram of a UE device 205, like the UE 101 or UE 151 in the FIG. 1, in which the present invention may be implemented according to one or more embodiments of the invention. The UE includes components for transmitting and receiving communications, including a UE communication manager 220, a I/O controller 255, a transceiver 235, a set of antennas 245, memory 225, and a processor (CPU: Central Processing Unit) 215. All these elements communicate with each other.

Memory 225 includes RAM (Random Access Memory), ROM (Read Only Memory), or combination of both or as a non-limiting example a mass storage device such as a disk or a Solid-State Drive. Basic Input Output System (BIOS) Instructions may be stored within the memory 225.

The processor 215 is configured to execute machine readable instructions. Execution of these machine-readable instructions causes the UE to perform various functions. These functions may be related to transmission or to interaction with peripheral devices like for instance a keyboard, a screen, a mouse, etc. (not shown in FIG. 2). The processor may run an operating system like for instance, iOS, windows, Android, etc. The processor 215 may be a single processor or may comprise two or more processors carrying out the processing required for the operation of the UE 205. The number of processors and the allocation of processing functions to the processors is a matter of design choice for a skilled person.

The I/O controller 255 allows these interactions with external peripherals by providing the hardware required and by managing input and output signals.

The transceiver 235 is configured to provide bi-directional wireless communication with other wireless devices. For example, it provides the necessary modems and frequency shifters necessary to connect to one or more wireless networks, such as Wi-Fi, Bluetooth, LTE, 5G NR, etc.

The radio communications use the antenna set 245 adapted to the spectrum of the frequency transposed signals, issued from the baseband modems. The antenna set 245 may be limited to one antenna, but preferably it contains several antennas, in order to provide beamforming capability.

UE communication manager 220 handles the communication establishment of the UE to a Radio Access Network, its control and its release. The UE regularly receives from the base station an indication of slots available for communication between the UE and base station. The UE then knows where in time and frequency it expects incoming data or must send its outgoing data, whether they belong to the control or data plane. In an example implementation, the UE communication manager 220 implements the Uu interface.

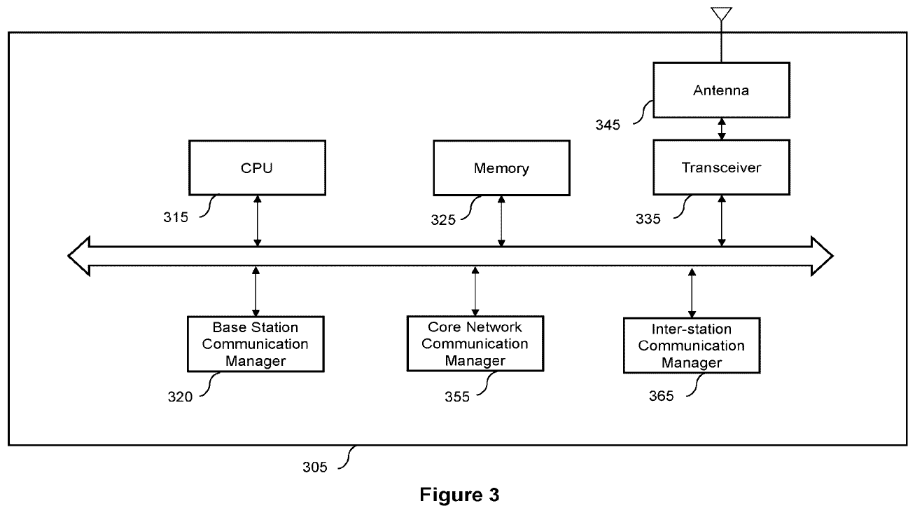

FIG. 3 illustrates a block diagram of a base station device 305, like the base stations or gNBs 110 and 111 in the FIG. 1, in which the present invention may be implemented according to one or more embodiments of the invention. The base station device 305 includes components for transmitting and receiving communications, including a Base Station communication manager 320, a Core Network communication manager 355, a transceiver 335, a set of antennas 345, memory 325, a processor (CPU) 315, and an Inter-Station communication manager 365. All these elements communicate with each other.

The Base Station communication manager 320 handles the communications with a plurality of UEs. It is responsible for the establishment, the control and the release of these communications. In an example implementation, the Base Station communication manager 320 implements the Uu interface. The Base Station communication manager 320 includes a scheduler that allocates time frequency slots to the different UE communications. Information regarding the schedule of these slots is regularly sent to the involved UEs.

The Core Network communication manager 355 manages communications of the base station with the core network. It may provide a standardized NG interface, as defined by the 3GPP standard, to support these communications.

The transceiver 335 is configured to provide bi-directional wireless communication with other wireless devices. These devices may be UEs, or even other base stations. The transceiver 335 provides the necessary modems and frequency shifters in order to connect to a large number of UEs simultaneously, using different frequency carriers, in Time Division Duplex (TDD) or in Frequency Division Duplex (FDD). The transceiver 335 is connected to the antenna set 345, that may be limited to one antenna, but preferably it contains several antennas, in order to provide beamforming capability.

Memory 325 includes RAM, ROM, or combination of both or as a non-limiting example a mass storage device such as a disk or a Solid-State Drive. BIOS Instructions may be stored within the memory 325 to support an operating system.

The inter-station communication manager 365 manages communications with other base stations. The Inter-Station communication manager 365 may provide a standardized Xn interface, as defined by the 3GPP standard, to support these communications.

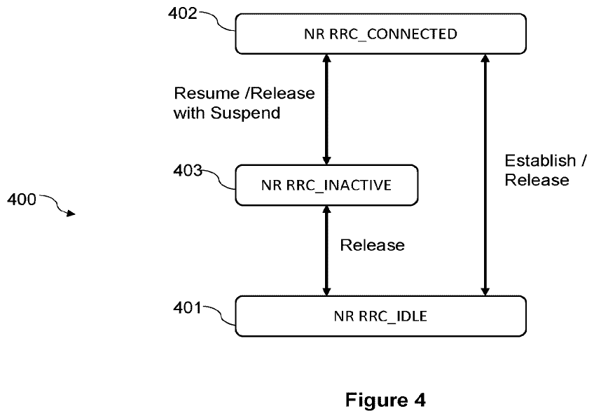

FIG. 4 is a flowchart 400 showing the RRC connection states and transitions for a UE in 5G NR. The RRC protocol operates between a UE and a base station (gNB) and is defined in 3GPP specifications TS 38.331 for 5G NR. The UE's state names are prefixed with “NR” for New Radio. Other prefixes are used for other radio interfaces like LTE radio interface. For the sake of simplicity, the radio technology prefix is omitted in the rest of the description.

Radio Resource Control (RRC) is a layer within the 5G NR protocol stack. It exists only in the control plane, in the UE and in the gNB. The behaviour and functions of a base station and a UE are governed by the current RRC state of the UE. In 5G NR, three distinct RRC states are specified for a UE: RRC_IDLE state 401, RRC_CONNECTED state 402 and RRC_INACTIVE state 403.

At power-up the UE is in RRC_IDLE state 401, it performs radio link quality measurements and executes the cell selection evaluation process (as defined in 3GPP specifications TS 38.304) to identify a target gNB to connect to. The UE state changes to RRC_CONNECTED state 402 upon an RRC connection establishment with the target gNB that becomes the source gNB serving the UE. In the following, the source base station (or source gNB) may also be referred to as the serving base station or serving gNB. If there is no radio activity for a while, the RRC connection can be released by the source gNB, then the UE's RRC state changes back to RRC_IDLE state 401.

While releasing an RRC connection is interesting for capacity utilization and power saving, it is not ideal from the latency perspective. The overhead in establishing an RRC connection requires extra signalling that introduces delay. To cope with this drawback, the RRC_INACTIVE state 403 has been introduced for 5G NR. When the UE is in RRC_INNACTIVE state 403, the UE cannot communicate with the 5G system, but both the source gNB (e.g., last serving gNB) and the UE store the UE context or configuration. The stored UE context or configuration includes information to facilitate quick resumption of the connection. The information may include the security context (e.g., security parameters such as security key, UE security capabilities), measurement configuration, radio configuration (e.g., UE radio capability), information about bearers, PDU (Protocol Data Unit) session context etc. Thus, when in RRC_CONNECTED state 402, the RRC connection can be suspended by the source gNB (Release with suspend), and the UE moves to the RRC_INACTIVE state 403. From the RRC_INACTIVE state 403, the UE can be switched back to the RRC_CONNECTED state 402 by the gNB (Resume) and the UE applies the stored UE context or configuration. The RRC resume message is sent by a gNB upon reception of a RRC resume request message from the UE.

From either the RRC_CONNECTED state or RRC_INNACTIVE state, the UE can transit to RRC_IDLE state upon a RRC release command received from the gNB.

The mobility procedure to migrate a UE from one cell to another depends on the UE's RRC state. In RRC_CONNECTED state, the mobility procedure, called handover, is controlled by the network, and the source gNB takes the decision to trigger the handover procedure based on the measurement reports provided by the UE. In RRC_INACTIVE and in RRC_IDLE states (e.g., non-connected states), the mobility procedure is called cell re-selection, and it is managed by the UE itself.

In RRC_INACTIVE state, the UE can be configured by the network with a RAN Notification Area (RNA). For example, the message that transitions the UE to the RRC_INACTIVE state contains information indicating the RNA. The RNA is the area within which the UE can move without notifying the network. When the UE in the RRC_INACTIVE state moves to a cell that is not part of its currently assigned RNA, the UE performs a location-update procedure that enables the RAN (e.g., serving gNB) to update the RNA assigned to the UE. In other words, the UE has the possibility to request an RNA update to be informed of a modification of the RNA. When, as part of the cell re-selection process, the UE selects a cell managed by a target gNB out of the RNA, the UE sends a resume request to the target gNB, which has three options available: to keep the UE in RRC_INACTIVE state, to set the UE in RRC_IDLE state, or to set the UE in RRC_CONNECTED state.

In RRC_IDLE state, the paging procedure to inform a UE that it has to resume the connection is initiated by the core network. In RRC_INACTIVE state, the paging procedure is initiated by the NG RAN (i.e., the last gNB that had set the UE in RRC_INACTIVE state).

Back to the FIG. 1, it is assumed that the UE 101 is in the RRC_INACTIVE state and that it is receiving multicast data of one or more multicast MBS sessions generated by the multicast application server 103. The multicast data are provided to the base station 111, which is the base station controlling the cell 121 on which the UE 101 is camping, through the core network 102 and the transport bearer (also known as GTP-U tunnel) 106 over the link 141. Then, the multicast data are transmitted by the base station 111 to the UE 101 through the MBS Radio Bearer (MRB) 154. FIG. 1 also shows the UE 151 receiving data through MRB 153. In a point-to-multipoint transmission of data from the base station 111, the MRB 154 is the same MRB as MRB 153. In a point-to-point transmission, the MRBs 154 and 153 are different. A radio bearer is a set of PHY (layer 1) and MAC (layer 2) parameters allowing higher layer data connection between a UE and a gNB. Multiple types of radio bearers are defined in 5G NR: the SRB (Signalling Radio Bearer) for the control plane, the DRB (Data Radio Bearer) allowing point-to-point communication with one UE in the user plane (unicast), and the MRB allowing point-to-point communication and point-to-multipoint communication with multiple UEs (multicast/broadcast), also in the user plane.

The MBS session join procedure, as specified in 3GPP TS 23.247, is used by UEs to inform the 5GC of an interest in joining a multicast MBS session. The first accepted UE join request triggers the multicast MBS session establishment towards the NG RAN and the UE. Before sending a join request for a multicast MBS session, the UE should have established a PDU session that can be associated with multicast session(s), using the procedures as specified in TS 23.502. Also, the UE should know at least the MBS Session id of a multicast group that the UE can join, via service announcement broadcasted by the network. To join the multicast group, the UE sends a PDU Session Modification Request for the associated PDU session which contains one or several MBS Session id(s) and a join request. The MBS Session id(s) indicates the multicast MBS session(s) that UE wants to join.

To join an MBS session, the UE has to be in the RRC_CONNECTED state.

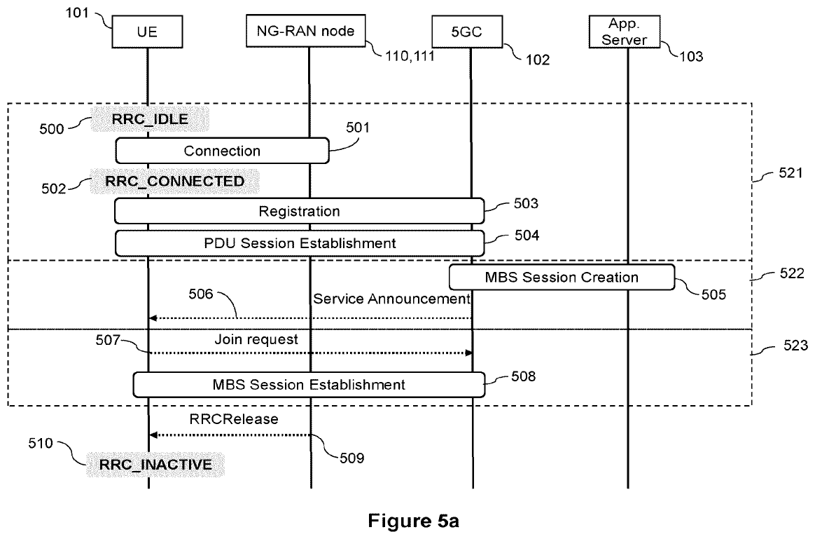

FIGS. 5a and 5b together illustrates example message flows for an example scenario of MBS session evolution from creation to activation. FIG. 5a illustrates an example message flow for MBS session creation and establishment and FIG. 5b illustrates an example message flow for MBS session activation.

Referring first to FIG. 5a, UE, for example UE 101 (or it could be UE 151), is powered up and enters the RRC_IDLE state 500. During step 501, the UE connects to the closest gNB (for example, in the case of FIG. 1, UE 101 connects to gNB 111) as a result of the cell selection process defined in TS 38.304 clause 5.2.3. Once connected to the gNB, the UE enters the RRC_CONNECTED state 502. Then the UE executes the registration process or procedure 503 aiming at identifying the UE in the core network or 5GC 102, checking the UE subscriptions and enforcing the authorisations. The registration procedure is detailed in TS 23.502 clause 4.2.2.2.

After registration, the UE creates a first PDU session via a PDU session establishment procedure 504. The first PDU session is a default PDU session allowing access to 5G core services. This PDU session can be later associated to the MBS session. PDU session establishment procedure is defined in TS 23.502 clause 4.3.2.

The AF (Application function) 104, in the 5G core 102, creates a multicast session on demand of the application server 103. The MBS session creation procedure 505 for creating the multicast session is defined in TS 23.247 clause 7.1.1. The session creation is driven by the AF 104 (Application Function), and on completion, the result is an MBS session id (for example, TMGI for Temporary Mobile Group Identity) allocation for the multicast session and session creation.

Once the multicast session is created, the AF 104 performs a service announcement 506 towards the UEs, e.g., the AF 104 sends a service announcement message. The service announcement message includes multicast session information which includes, among other things, the multicast MBS session id, service area description (or information) and session description information. Service announcement is described in TS 23.247 clause 6.11. Some UEs may not need to receive the service announcement message. For example, service information provided in the service announcement can be pre-configured at some UEs. Also, UEs that are not connected at the time of the service announcement can access the service information by soliciting directly the AF 104 (Application Function) or MBSF (MBS Service Function) in the core network 102.

There are no timing dependencies between UE connection/registration/PDU session establishment procedures (collectively identified by reference number 521) and MBS session creation/announcement procedures (collectively identified by reference number 522). Both 521 and 522 are performed independently from each other and can happen at any time. Once the UE 101 is registered in the core network 102 and a default PDU session is established and multicast service information is known, then UE may send or perform a join request 507 to the core network 102 to enrol in the multicast session. The multicast session information (such as, multicast MBS session id, etc. as described above) is known by the UE either after receiving the service announcement message 506, or by pre-configuration, or by soliciting the information from the core network (message flow for pre-configuration of or soliciting session information is not shown in FIG. 5a or 5b). To join a multicast session the UE may reuse the default PDU session created earlier (at 504), and send a PDU session modification request including the multicast session id (TMGI). The PDU session modification request is then considered as a join request (507). Another possibility is to establish a dedicated MBS PDU session including the multicast session id for join request 507.

When the core network 102 receives a join request 507, it performs the multicast session establishment procedure 508. During the session establishment procedure 508, the core network 102 verifies the UE's subscriptions and authorization levels to check if the UE is allowed to access the multicast session (i.e., to check the UE is one of a particular multicast group of UEs authorised to receive the multicast session). Also, as part of the session establishment procedure 508 the core network 102 will setup necessary resources in the core network to covey the multicast data from the application server 103 to the concerned gNBs. The concerned gNBs are defined by the multicast service area information established at session creation step 505. The join procedure 507 and the multicast session establishment procedure 508 are defined in TS 23.247 clause 7.2.1.

In the example shown in FIG. 5a, the gNB of the NG-RAN (e.g., gNB 111) decides to switch the UE 101 to RRC_INACTIVE state 510 by sending a RRCRelease message 509 (TS 38.331 clause 6.2.2). The most common reason is load management, the gNB may decide to offload its control plane load by switching some UEs to RRC_INACTIVE. Also, on-going discussions for Release 18 suggest that both UEs and core network provide additional information to the gNB to help the gNB take the decision to switch some UEs to RRC_INACTIVE state. The additional information may include capacity information from both UE and Core network indicating the ability to send or receive multicast data in RRC_INACTIVE state. Other information may also be provided by the UEs to express a preferred state for receiving the multicast data: i.e., RRC_INACTIVE or RRC_CONNECTED.

Referring now also to FIG. 5b, with the UE in RRC_INACTIVE state 510, UEs shall perform as a background task the cell re-selection process 511. This process manages the UE mobility allowing “reselecting” a new gNB depending on the new UE location. Cell re-selection is described in detail in TS 38.304 clause 5.2.4. In this example it is assumed that the NG-RAN node is either gNB 110 or gNB 111 depending on UE movement. It is noted that the cell reselection 511 is an optional step in the method shown in FIG. 5b, as denoted by the dashed outline. Further such optional method steps are denoted by dashed lines in subsequent figures.

Once the MBS session is created (505), the AF 104 (Application Function) in the core network 102 can be triggered to activate the multicast session (i.e., MBS session activation 512). The trigger to activate the multicast session is independent from the join and session establishment procedures (collectively identified by reference number 523). One possible trigger is the availability of data from the application server 103. Multicast session activation is described in TS 23.247 clause 7.2.5.2. The main result of this procedure is the RAN (Radio Access Network) resource reservation by the gNBs. These resources allow the communication of the multicast data to the UEs that has already joined the multicast session. The RAN resources allocation includes the MRB (MBS Radio Bearer) configuration. Each gNB will use a particular configuration for the MRB for the multicast session.

Once the multicast session is activated on completion of the MBS session activation 512, the core network 102 may need to page some UEs to notify them of the availability of the multicast data. RRC_INACTIVE UEs need to be paged because as explained in 510, RRC_INACTIVE UEs are still moving and may enter into the cell of another gNB, but neither the new gNB (target gNB) nor the first gNB (source gNB) are aware of the UE movement at this step (i.e., at the time the multicast session is activated 512). The core network 102 sends a group paging message to the gNBs with the MBS session id (not shown in FIG. 5b), then each gNB sends a group paging 513 message with the multicast session id. This sequence is described as step 5 in TS 23.247 clause 7.2.5.2.

Upon reception of the group paging message 513, RRC_INACTIVE UEs shall prepare to resume the RRC connection during the processing 515.

As part of the RRC connection resume preparation, the UE 101 performs a Random Access procedure toward the gNB (PRACH procedure 516, PRACH stands for Physical Random Access Channel). The PRACH procedure aims at updating the UE's system information in case it has moved to another cell or in case the system information has not been updated for a while. Then the UE 101 performs and completes the connection resume procedure in 517, which includes sending a RRCResumeRequest message (not shown in FIG. 5b). The connection resume procedure 517 follows the RRC connection procedure which is defined in detail in TS 38.331.

Once the RRC connection procedure is done, the UE is in RRC_CONNECTED state 518.

It is only at that step when the UE 101 is in RRC_CONNECTED state 518 that the gNB 111 may send the multicast configuration (including the MRB information) to the UE, step 519, which includes sending a RRCReconfiguration message (TS 38.331 clause 6.2.2) including the MRB information.

Once the UE applies the received multicast configuration, it can receive the multicast data in 520.

As discussed in the introduction, with the UE having to switch from the RRC_INACTIVE state into the RRC_CONNECTED state to perform the configuration for multicast reception, the additional signalling and other resources required to configure the UE in the RRC_CONNECTED state adds to the load issues at the NG-RAN node, gNB, (i.e., too many UEs in the RRC_CONNECTED state), and so the benefits of having UEs switched to the RRC_INACTIVE state to avoid congestion are lost or at least reduced. For example, the paging, PRACH, processes to resume to the RRC_CONNECTED state then MBS configuration, as discussed above, can cause link congestion and delay issues.

The following embodiments provide a method for configuring UEs to receive multicast data while in RRC_INACTIVE state that simplifies the procedure of FIG. 5b. This is because the RRC resume procedure followed by the MBS configuration can be skipped if the UE is pre-configured to receive in such conditions.

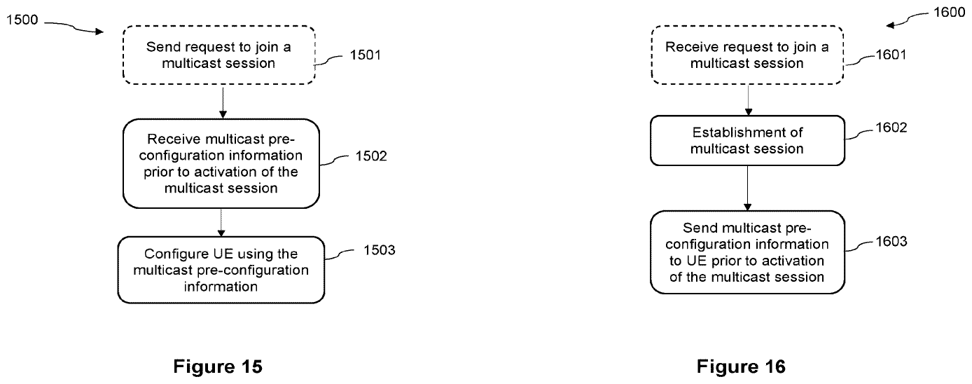

An embodiment of the invention is shown in FIG. 15 which is method 1500 performed at a UE. At 1501, the UE may send a request to join a multicast session. In 5G NR the request is typically sent to the core network via a base station such as a gNB 110, 111 but it is envisaged that, in alternative implementations, it may be sent to or via another network entity, for example a UE acting as a relay.

Multicast pre-configuration information is received by the UE at 1502 prior to activation of the multicast session which the UE has requested to join. Session activation may be MBS session activation, for example, as described above with respect to 512 of FIG. 5. The pre-configuration information may be received from a base station or another entity in the network such as a UE acting as a relay. The UE may then perform configuration according to the multicast pre-configuration information so as to receive multicast data via the multicast session (1503).

FIG. 16 shows a flow chart 1600 having steps performed at a base station according to an embodiment. At 1601, a request made by a UE to join a multicast session may be received by the base station. The request is for the core network and accordingly such a request may then be forwarded (sent) by the base station to the core network 102. At 1602, a multicast session is established. In other words, the base station participates in the multicast session establishment process to establish the session between a UE and a core network. This will include receiving information from the core network in response to the join request as part of an establishment process. The multicast session establishment may comprise the MBS session establishment 508 described in connection with FIG. 5 which establishes the MBS session requested by a UE 101 between the UE 101, gNB 110, 111 and core network 102. Subsequently, at 1603, and prior to activation of the multicast session, multicast pre-configuration information is sent to the UE.

In this description, “multicast pre-configuration information” means configuration information (data) that is received and stored, to be applied later in the appropriate situation. According to some embodiments it is received before multicast (MBS) session activation of the session to which the pre-configuration information relates. In other embodiments, a UE may receive multicast data after multicast (MBS) session activation, and the network provides pre-configuration data to pre-configure the UE to receive multicast data after cell switching as a result of a cell re-selection process. Depending on the implementation, it can be used to configure the UE before and/or after the multicast (MBS) session activation. Where we specifically refer in the description to ‘multicast (MBS) pre-configuration’ of a UE this refers to the act of applying received multicast pre-configuration information in the appropriate situation to receive multicast (MBS) session information.

Sending and receiving the pre-configuration information prior to activation enables the network to alleviate the configuration load and the signalling overhead when receiving the first multicast data. This mitigates the risk of overloading the cell (i.e., the radio resources in the cell) and/or the gNB (i.e., the processing resources at the gNB) when configuring all involved UEs with the radio resources they require when the session becomes activated.

According to embodiments, a UE can be configured at different stages. In an embodiment, a network can configure the UEs after a join request made by the UE, and upon arrival of first multicast data. Hence, when the network is ready to configure a UE, it generates a triggered Information Element or message which is sent to the UE.

Different scenarios are described in the sections below and, depending upon the triggering event(s), different possibilities exist for sending the multicast pre-configuration information. For instance, the triggering event may be the multicast establishment at the network side i.e., once the multicast configuration context is available at the network side, a multicast pre-configuration message is sent (e.g., by a base station) to one or more (candidate) UEs.

Other triggering aspects may be evaluated by the network e.g., the decision of which UEs are suitable candidates for the multicast session (e.g., based on the UE's capabilities). Once the group of candidate UEs is determined, the network may then trigger a multicast pre-configuration message to the identified group of UEs.

For example, candidate UEs may be those with the capabilities listed below:
able or preferring to receive multicast data in RRC_INACTIVE state,
receiving multicast data in RRC_CONNECTED state with low QoS.

In some scenarios, the UE may request the pre-configuration and hence, triggering a multicast pre-configuration message sent by the network side (i.e., from a base station).

The multicast pre-configuration information may include one or several pre-configurations, each pre-configuration may consider different information elements including but not limited to:
multicast Radio Bearer “MRB2” configuration dedicated to receiving multicast data with low QoS for candidate UEs, or “MRB1” configuration mainly addressed for UEs in RRC_CONNECTED state with high QoS,
an RRC_INACTIVE reception indication where the gNB indicates to the UEs if they are enabled to receive multicast data in RRC_INACTIVE state (the absence of this indicator means that UE can receive by default multicast data in RRC_INACTIVE state),
G-RNTI identifying a group of UEs within the same cell interested in receiving multicast data,
multicast pre-configuration ID referring to the configuration applied for UEs and associated with the MBS session ID (e.g., TMGI),
discontinuous reception (DRX) configuration used to receive multicast data for candidate UEs,
neighbour cells multicast configuration applied when candidate UEs perform handover or cell re-selection,
cell ID(s) identifying the cell(s) in which the pre-configuration shall be applied.

The multicast configuration or pre-configuration of an MBS session may have common information elements used for all the NG-RAN nodes located within the MBS service area and thus, the UE has common configuration that could be applied wherever in the MBS service area. Thus, cell (re) selection or handover becomes transparent to the mobile UE.

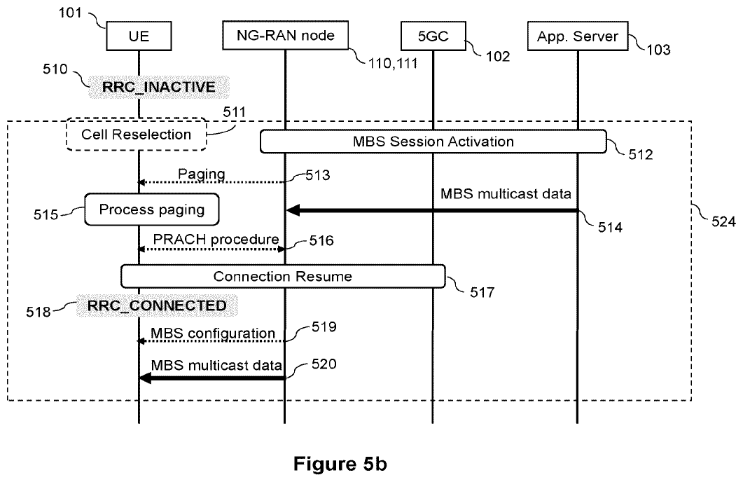

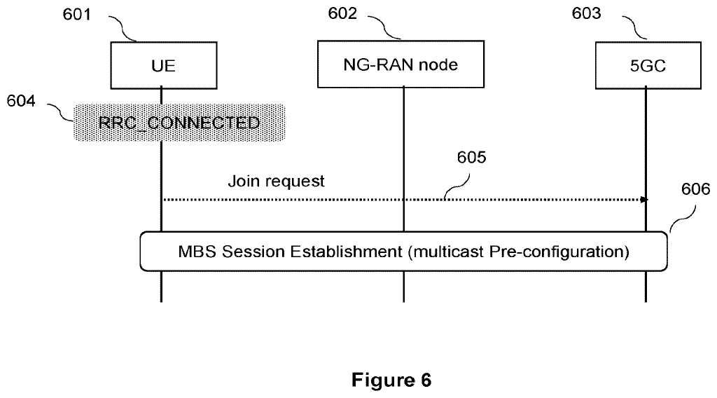

The following description sets out different embodiments of sending multicast pre-configuration information at different stages with different possible triggering events. These include:
at MBS session establishment (or after) in an RRC_CONNECTED state (FIG. 6),
when a UE switches to RRC_INACTIVE state,
when a UE is in RRC_INACTIVE state,
most of the scenarios cover possible handover in RRC_CONNECTED state or cell (re) selection in RRC_INACTIVE state.

In a first scenario, to send an MBS multicast configuration to a UE, the NG-RAN node must have performed radio resources reservation corresponding to the MBS session requirement like the QoS flow information or the RRC state of reception (RRC_CONNECTED, RRC_INACTIVE).

During the UE join request procedure the gNB has enough information to perform radio resource reservation for UE reception in both RRC_INACTIVE and RRC_CONNECTED states. According to an embodiment, based on this knowledge the pre-configuration information (corresponding to RRC_INACTIVE and RRC_CONNECTED) are sent by the gNB to the core network, then the core network sends it to the UEs. Thus, the UEs configuration is distributed in time ahead of the session activation.

FIG. 6 is a flowchart illustrating the sending of multicast pre-configuration information after a join request by a UE, according to an embodiment based on the first scenario.

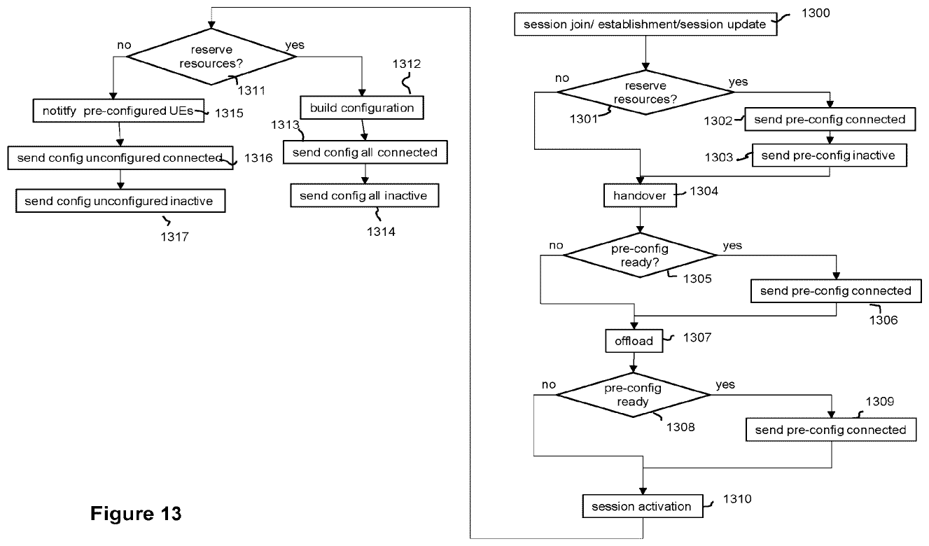

The UE in 601 belongs to a group of candidate User Equipment UEs able to receive multicast data with low QoS as described previously. This UE 601 is in RRC_CONNECTED state 604 and attempting to join the MBS session. After an announcing message 506 from the 5GC in 603 informing about an MBS session creation with the associated TMGI (i.e., Temporary Mobile Group Identity used as valid MBS session ID), the UE 601 will proceed with the session joining step 605 (or alternatively a session update) and then the session establishment in 606. In an embodiment, these steps correspond to step 1300 described below with respect to FIG. 13. The UE in 601 may inform NG-RAN node 602 and 5GC 603 about its capability and/or preference to receive multicast (MBS) data with low QoS or to receive multicast (MBS) data in RRC_INACTIVE state. This information can be sent earlier at the registration stage or during the join request.

After accepting the join request, an MBS session establishment procedure is performed in 606 between the UE in 601, the NG-RAN node in 602 and the 5GC in 603. In 606, a multicast session context is created and associated to the UE in 601. In Release 17, MRB contexts could be configured and included in the multicast session context and radio resources can be reserved as in 1301. At this stage, MRB contexts refer either to MRB1 or MRB2 contexts for UEs allowed to receive multicast data in RRC_CONNECTED state (TS 38.401 clause 6.4 and TS 23.247 clause 7.2.1.3) whereas no MRB context is available to receive in RRC_INACTIVE state.

In this embodiment, a pre-configuration may be added to the MBS session establishment procedure 606 and radio resources can be reserved as in step 1301. In other words, the multicast pre-configuration information is sent to the UE upon multicast session establishment. Thereafter, UEs pre-configured at this stage using the received multicast pre-configuration information can receive multicast data in RRC_INACTIVE state.

The multicast (pre)-configuration may refer to a multicast Point-to-Multipoint (PTM) configuration in the description below, allowing a shared delivery of multicast data over radio to one or multiple UEs. The multicast PTM configuration is applied to a UE receiving multicast data in the RRC_INACTIVE state.

For instance, the multicast pre-configuration information can be added to the multicast session context already existing in the MBS session establishment procedure 606. Another implementation consists of creating new multicast pre-configuration session context separately and then added to the procedure in 606. The multicast pre-configuration session context is then added to the information elements to be exchanged with the UE at the MBS session establishment stage and sent through RRC Reconfiguration message.

The multicast pre-configuration context should be established by the network earlier or at the moment of the MBS session establishment 606 and therefore, it can trigger a multicast session context modification and/or creation in 606. Another condition could be added to the triggering event such as the candidate UE portfolio.

Multicast pre-configuration information includes the MRB1/MRB2 configuration(s) as well as a list of information elements mentioned above. The network can choose a shared delivery of multicast data to multiple UEs through a multicast PTM pre-configuration. Otherwise, the UE can be pre-configured for an individual delivery and thus, a dedicated multicast pre-configuration is designated.

When the MBS session is activated, and the UE 601 is in RRC_INACTIVE state, it can then apply its multicast pre-configuration to receive multicast data. It is not necessary to resume the RRC_CONNECTED state.

The multicast pre-configuration context may be established after the MBS session establishment in 606 and thus, it triggers various multicast pre-configuration messages sent to the UE 601 depending upon its RRC state. The following scenarios depict other alternatives to configure/pre-configure the UE by receiving pre-configuration information under different timings and/or conditions.

Some UEs are always moving, and it can happen that a UE moves after receiving pre-configuration information from a gNB. So, when a gNB hands over a UE in an RRC_CONNECTED state to another gNB because the UE has moved, it is important that the new gNB changes the UE pre-configuration information to match its resources. Thus, in this second scenario, the pre-configuration information is always accurate in case of UE moving to other cells.

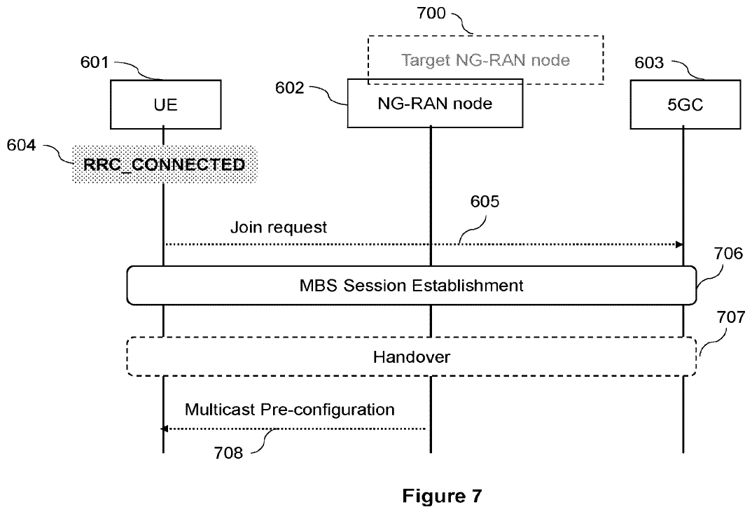

FIG. 7 is a flowchart illustrating the sending of UE pre-configuration after handover according to an embodiment applicable in the second scenario.

The network can choose to pre-configure the UE in 601 independently from the MBS session establishment procedure in 706. Furthermore, the multicast pre-configuration context may be setup by the network after the MBS session establishment 706 and then, it may trigger a message in 708 to send pre-configuration information to the UE 601 which can be used to pre-configure or configure the UE. The scenario in FIG. 7 considers that the multicast pre-configuration/configuration context is available after the MBS session establishment 706 whereas the UE is in RRC_CONNECTED state. The NG-RAN node 602 may include this context in the multicast pre-configuration message in 708. Other triggering conditions related to the candidate UE portfolio may be required to send the multicast pre-configuration message in 708.

The message in 708 corresponds to the step 1302 if the UE is in RRC_CONNECTED state wherein the pre-configuration message is sent. The message 708 could also be equated to the step 1306 of FIG. 13 (described below) if handover is performed in RRC_CONNECTED state.

In an example, the message in 708 may be sent in one or multiple RRC messages such as RRCReconfiguration message, RRCRelease message with, for example, SuspendConfig- or dedicated System Information Block (SIB) to the UE in 601. The message may include various information elements and mainly the MRB2 configuration.

A handover can occur in 707 before the multicast pre-configuration information is received, the candidate UE in 601 is not yet pre-configured. During the handover procedure, the source NG-RAN node 602 may exchange the UE capability and preferences (i.e., RRC_INACTIVE/CONNECTED multicast reception with low QoS) with the target NG-RAN node in 700. Therefore, the target NG-RAN node 700 may choose to pre-configure this UE by sending the multicast pre-configuration message.

For instance, the handover 707, 1304 may occur after the source multicast pre-configuration message in 708, the target NG-RAN node 700 should send then the target multicast pre-configuration message. Another alternative consists of including in the source multicast pre-configuration message 708, the list of neighbour cells with the corresponding multicast pre-configurations/configurations. In this case, the UE in 601 being handed over the target NG-RAN node 700 will be able to apply the target multicast pre-configuration without the need to be pre-configured again.

In a particular case where the source 602 and the target NG-RAN 700 nodes are within the same MBS service area, and a common multicast pre-configuration/configuration context is shared within the MBS service area, the UE 601 can be pre-configured/configured once within the MBS service area.

We can consider a third scenario in which, when a UE performs a join request procedure, it may indicate its capability and preferences in term of RRC state for reception. As part of session establishment, the gNB knows also the capability/preference of the application regarding the RRC state for reception by the UEs. At any time for the need of load management the gNB may decide to switch some UEs to RRC_INACTIVE state using the RRC release procedure. As part of the RRC release procedure the gNB may send or update the pre-configuration to UEs to be switched. Thus, it is possible to update the resource reservation as a response to a load stress in the gNB ahead of the session activation.

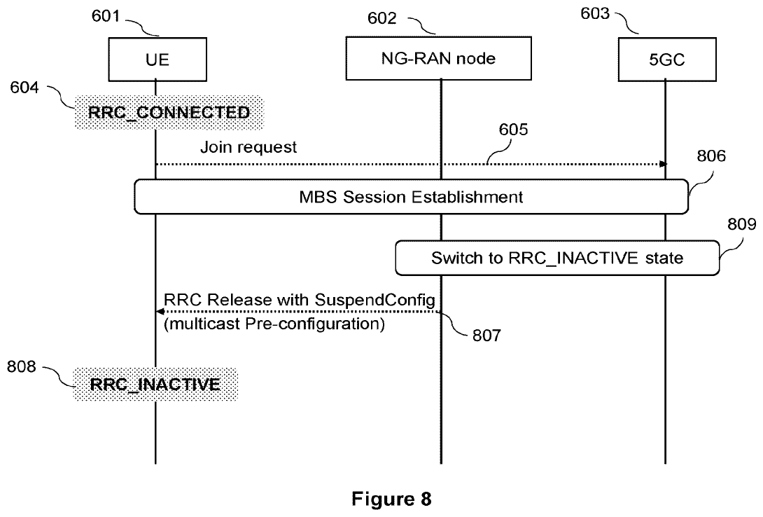

FIG. 8 is a flowchart illustrating the sending of UE pre-configuration as part of RRC_Release procedure according to an embodiment that is particularly useful in the above mentioned third scenario.

In particular, FIG. 8 shows another alternative for pre-configuring one or more UEs capable and/or preferring to receive multicast data with low QoS in RRC_INACTIVE or RRC_CONNECTED states. The process shown in this figure corresponds to the offload step in 1307 of FIG. 13 which will be described in more detail below. After a join request 605 and MBS session establishment 806, a UE 601 can receive multicast data in RRC_CONNECTED state as in Release 17. The UE 601 is considered as a candidate UE by the NG-RAN node in 602.

NG-RAN node 602 may choose to switch a group of UEs to RRC_INACTIVE state to control the signalling overhead and to reduce the power consumption. NG-RAN node (602) may decide to pre-configure the candidate UEs of the group to remain in an RRC_INACTIVE state and receive multicast data.

In an example, the network 602, 603 decision in 809 may trigger the multicast pre-configuration message sent in 807 and referred in 1309. The triggering event may be correlated with the availability of the multicast pre-configuration context at the network and the portfolio of the switched UE.

To this end, the NG-RAN node 602 may use a RRCRelease with SuspendConfig message in 807 and 1309 with an amendment of its content. Additional fields related to the multicast pre-configuration context can be included and thus, the candidate UE in 601 performs its transition to RRC_INACTIVE state 808 and is aware that by then, it is pre-configured to receive multicast data while remaining in RRC_INACTIVE state. An RRC_INACTIVE reception indicator may be added to the multicast pre-configuration message to inform the pre-configured UE that it is allowed to receive while in RRC_INACTIVE state. This field is optional and its absence enables the UE to receive multicast data by default when in RRC_INACTIVE state, upon arrival of multicast data at the UE.

The NG-RAN node 602 may choose to send the multicast pre-configuration information in a separate multicast pre-configuration message before the RRCRelease message. The separate message may be sent in RRC or dedicated SIB container types by a way of example. In this description we use the term SIB as a simplification of SIB+MCCH, meaning using System Information Block and/or MBS Control Channel message. For example, MCCH scheduling information can be provided via SIB, or alternatively the whole information can be contained in the SIB.

In a fourth scenario, the gNB may process to the release of the UEs and their transitions to RRC_INACTIVE state with no modification to the RRCRelease procedure. A paging message issued by the gNB may indicate to the interested UEs of possible multicast pre-configurations in RRC_INACTIVE state.

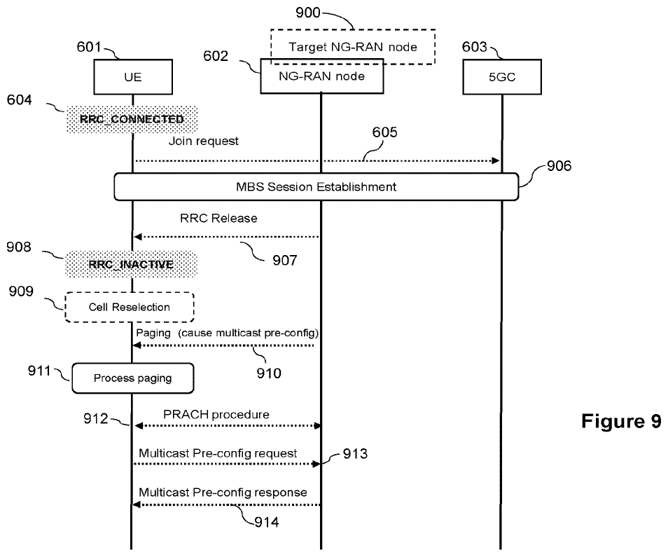

An embodiment related to the fourth scenario, is shown in FIG. 9 which is a flowchart illustrating the sending of UE pre-configuration triggered by a paging message.

The UE in 601 is a candidate UE that may receive multicast data in RRC_INACTIVE state. It sends a join request in 605 and an MBS session is then established in 906 between the UE 601, the NG-RAN node in 602 and the 5GC in 603.

The NG-RAN node 602 may decide to alleviate the signalling load and to switch a group of UEs to RRC_INACTIVE state in 908 by sending an RRCRelease message in 907.

In order to pre-configure the UE 601 in RRC_INACTIVE state as in step 1303, the NG-RAN node may send a notification message in 910. The notification of multicast pre-configuration availability may be any one of a paging message, an RRC message or a system information block, SIB.

The notification of multicast pre-configuration update may be any one of a paging message, an RRC message or a system information block, SIB.

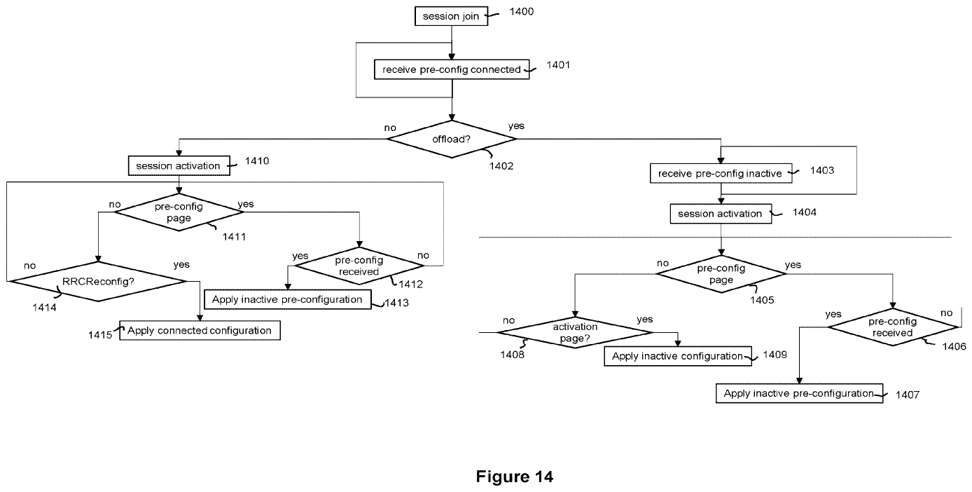

In FIG. 9, the message 910 is illustrated as a paging message for instance including the TMGI of the MBS session and the paging cause indicating that the paging is for multicast pre-configuration as in 1405 of FIG. 14 described below. The paging may be triggered by the network after the setup or an update of the multicast pre-configuration context.

The UE 601 in RRC_INACTIVE state may process the paging message in 911 and identifies the paging cause. If the UE in 601 is subscribed to the MBS multicast session and interested in receiving multicast data while remaining in RRC_INACTIVE state, a PRACH exchange procedure in 912 is initiated by the UE 601 with the NG-RAN node 602. In 912, the UE 601 requests uplink radio resources for L2/L3 messages. Next, the UE 601 sends a multicast pre-configuration request in 913 to the NG-RAN node 602, including its UE identity in RRC_INACTIVE state (e.g., the I-RNTI)

The NG-RAN node may send in response the multicast pre-configuration information in 914 (corresponding to 1406 of FIG. 14 which is described below) if the UE is suitable to receive multicast data. A reject message can be sent to the UE 601 with the reject cause. In an example, the UE in 601 may not be suitable to receive an RRC_INACTIVE state according to the network and thus, the RRC_INACTIVE reception indicator can be disabled and sent as the rejection cause.

A cell (re) selection in 909 may occur after switching the UE to RRC_INACTIVE state in 908. In this case, the steps 910-914 will be the subject of message exchange with the new target NG-RAN node in 900. The target NG-RAN node may send a notification message in 910. The notification message can be a paging message, a SIB or a dedicated RRC message.

In a way of example, the 910 message may be a group paging message including the TMGI of the MBS session and the paging cause indicating an available multicast pre-configuration at the target NG-RAN node. The UE 601 after a cell re-selection in 909 is not yet identified by the target NG-RAN node in 900. After processing the paging by the UE 601, PRACH exchange procedure in 912 is then initiated by the UE 601 with the target NG-RAN node (602) to indicate its presence in the target cell and to request radio resources for uplink signalling message exchange. If the UE 601 has already joined the MBS session and it is interested in receiving multicast data in RRC_INACTIVE state, it may send a multicast pre-configuration request to the target NG-RAN node in 913. The target NG-RAN node verifies then that the UE has joined the MBS session and it is capable and suitable to receive multicast data in RRC_INACTIVE state. Next, the target NG-RAN node may send a multicast pre-configuration response in 914 to the UE 601. The target NG-RAN node may reject the request while indicating the reject cause. The rejection cause may be a disabled RRC_INACTIVE reception indicator informing the UE that no multicast reception is allowed in RRC_INACTIVE state.

The multicast pre-configuration request in 913 can be sent in different container types. In an example, an RRC message such as RRCResume Request with additional fields for pre-configuration purpose can be employed. A SIB on demand could be used also by the UE to request the multicast pre-configuration.

The multicast pre-configuration information in 914 can be sent by the network using different container types. RRC messages such as RRCResume with the dedicated multicast pre-configuration, a RRCRelease with SuspendConfig or RRCReconfiguration message, then the UE remains in RRC_INACTIVE state. Otherwise, a SIB on demand sent by the UE in 913 may trigger a dedicated SIB in 914 sent by the network with the required multicast pre-configuration. In case of reject message in 914, it can be sent by RRC messages, dedicated SIB or other container types.

In a fifth scenario, the gNB may pre-configure the UEs that have switched to RRC_INACTIVE state by sending the multicast pre-configuration message.

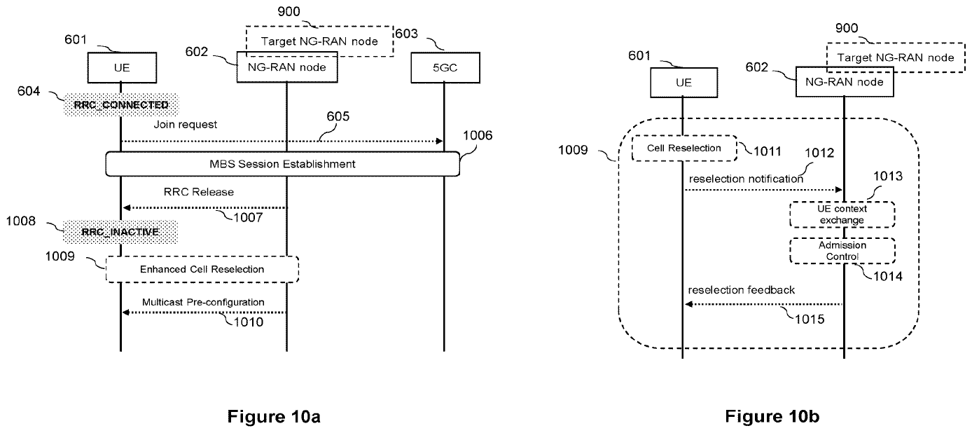

FIGS. 10a and 10b are flowcharts showing an embodiment particularly applicable to the above mentioned fifth scenario, that shows the sending of UE pre-configuration to a UE in RRC_INACTIVE state and applying an enhanced cell re-selection process.

FIG. 10a shows a UE in 601 attempting to join the multicast MBS session in 605 while in RRC_CONNECTED state 604. Next, the multicast MBS session is established in 1006 between the UE 601, the NG-RAN node 602 and the 5GC 603.

The UE in 601 is a candidate UE that may be capable and/or prefer to receive multicast data with low QoS whether in RRC_INACTIVE or RRC_CONNECTED state.

As with the embodiment of FIG. 9, the NG-RAN node 602 may choose to switch a group of UEs to RRC_INACTIVE state in order to relieve signalling load and reduce power consumption. Next, an RRCRelease message is sent in 1007 and the UE switches to RRC_INACTIVE state in 1008.

The network may trigger a multicast pre-configuration message in 1010 (corresponding to later referred to step 1303 of FIG. 13) where it includes the pre-configuration information elements needed to receive multicast data while in RRC_INACTIVE state. The UE applies a cell re-selection process in 1009 conforming to an enhanced cell re-selection process with an additional re-selection request message.

In a standard cell re-selection procedure, the UE performs measurement of signals from all neighbouring cells (gNBs). Then, based on the measurements and evaluation criteria, the UE selects the best candidate cell (gNB). If the selected cell (gNB) is not the current one (the cell the UE is camping in i.e., a source cell) then the UE changes to the new cell (a target cell).

In the enhanced cell re-selection procedure, when a new cell is selected as best candidate by the UE, a re-selection request message is sent by the UE to the source gNB (old cell) prior to changing cell. The re-selection request message includes the target cell identification. On reception of the request message, the source gNB informs the target gNB that the UE will camp on the target cell (new cell) and is participating to an MBS session.

In an alternative embodiment the UE sends the re-selection request message to the target gNB after changing the cell. In this alternative embodiment the re-selection request message includes the MBS session information.

As a result of the enhanced cell re-selection process, the gNB knows the RRC_INACTIVE UEs in the cell, these UEs have up to date system information and, as a result, the page, PRACH and (pre)-configuration request steps can be skipped. Further details of said enhanced cell re-selection process can be found in UK patent application no. GB2205138.7.

For instance, the multicast pre-configuration context may include MRB2 contexts, multicast configuration ID, associated G-RNTI, DRX configuration and neighbour cells multicast pre-configuration. The triggering event may depend upon the network establishment of the multicast pre-configuration context or the UE (601) portfolio. In a way of example, the network may select the group of UEs candidate to receive while in RRC_INACTIVE state and thus, the selection triggers the multicast pre-configuration message. The multicast pre-configuration information in 1010 can use different container types. For example, RRC messages can be suitable to carry the multicast pre-configuration information in particular, the RRCReconfiguration or RRCRelease with SuspendConfig messages can be employed with additional fields locating the multicast pre-configuration context. The network can employ other alternatives, by a way of example, the multicast pre-configuration context can be sent in dedicated SIBs to pre-configure the UE 601 or a group of UEs for shared delivery.

The enhanced cell (re) selection is considered in FIG. 10b wherein the UE (601) is in RRC_INACTIVE state 1008. The procedure 1009 is slightly different than for FIG. 9 where a simple cell re-selection 909 is applied without informing the NG-RAN node 602. Subsequently, the UE 601 has to request the multicast pre-configuration in 913 once it receives a notification (paging in 910) from the network.

In the enhanced cell re-selection procedure in 1009, the UE 601 informs its arrival to the target NG-RAN node 900. Following this, UE context may be exchanged by way of example between the source NG-RAN node and the target NG-RAN node 900 including the UE capability and/or preference. The UE 601 can simply send its capability and/or preference and the relative G-RNTI of the target NG-RAN node in 1009. Thus, the target NG-RAN node may not need a prior exchange of UE context.

Target NG-RAN node 900 sends eventually the multicast pre-configuration to the UE in 601. The contents and the container types are as specified earlier in this section.

Other aspects of enhanced cell re-selection may be considered in this embodiment. The UE 601 may send a re-selection notification message in 1012 to the target gNB after a cell selection in 1011. The re-selection notification may indicate the presence of UE (601) in the target cell and/or request a multicast configuration from the target gNB (900). The 1012 notification message may include an MBS session ID (e.g., TMGI). The notification message in 1012 may be sent in RRCResume Request message.

The target gNB in 900 receiving the 1012 message may proceed to UE context exchange 1013 with the source gNB 602 and then the admission control 1014 as described in the UK patent application no. GB2205138.7. The steps in 1013 and 1014 may be skipped if the pre-configured UE provides a proof of authorization in the 1012 message. The proof can be the G-RNTI of the target cell corresponding to the group of UEs receiving multicast data for an MBS session ID. The target gNB 900 may then skip steps 1013 and 1014 and may send a re-selection feedback in step 1015. The G-RNTI information may be associated to the MBS session ID, the multicast configuration ID and/or to the cell ID in 1012 message. It may inform the target gNB if the UE (601) is allowed to receive multicast data. Furthermore, it may indicate if the UE has the authorization to receive multicast data for the corresponding MBS session in RRC_INACTIVE state.

The message 1015 may include a multicast (pre-) configuration to the UE or a simple rejection in case of no available authorization. The message container 1015 could be a RRCRelease with Suspendconfig including the configuration. A SIB message can be also employed.

Embodiments are now described which describe how the pre-configuration information received at a UE, according to any of the embodiments described herein, is used to configure a UE after session activation.

In one such embodiment, a multicast reception request can be sent by the UE upon the MBS session activation, it triggers the gNB to send multicast data for UEs in RRC_INACTIVE state. Furthermore, the UE may send a multicast reception feedback request to the gNB when receiving the first multicast data in RRC_INACTVE.

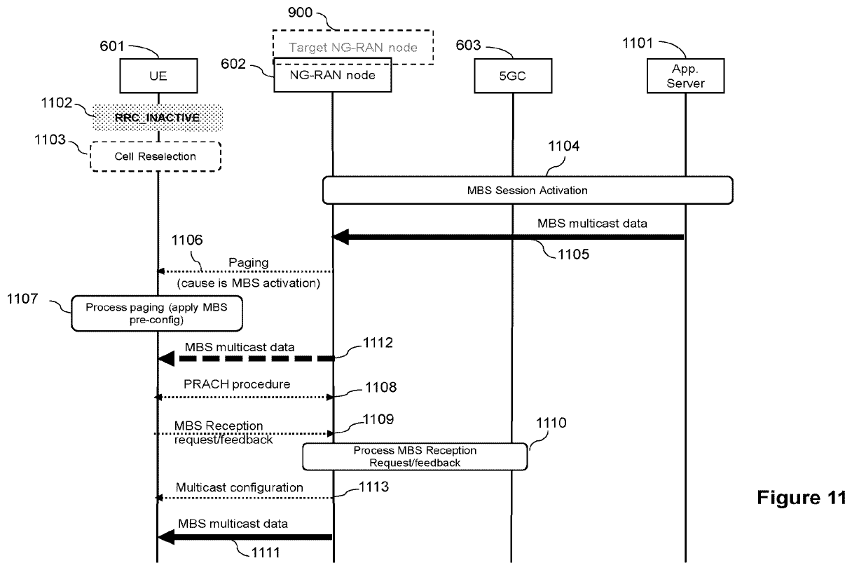

FIG. 11 is a flowchart illustrating the use of the pre-configuration by the UE after the session is activated, according to an embodiment.

The UE in 601 is in RRC_INACTIVE state 1102. Upon MBS session activation in 1104 and 1310, first multicast data arrive in 1105 to the NG-RAN node 602 and trigger a notification message. The notification message in 1106 can be a group paging message, a SIB or a dedicated RRC message. In this embodiment, and in a way of example the message in 1106 is a group paging message destined for the UE 601 in RRC_INACTIVE state. The paging message 1106 may include the MBS session ID (e.g., TMGI), and a paging cause indicating the MBS session activation of the corresponding MBS session as in 1408.

The UE 601 processes the paging message in 1107 (and 1409) and it may apply the multicast pre-configuration already sent previously by the network 602, 603. A PRACH exchange procedure in 1108 is initiated by the UE 601 with the NG-RAN node 602, it allows to request uplink radio resources for future signalling message exchange with the NG-RAN node.

The steps in 1109 and 1113 depend upon the status of the UE 601 in 1107. The UE 601 may have been pre-configured previously by the NG-RAN node or may request pre-configuration or reception in RRC_INACTIVE state. The example below states the possible messages to be carried in step 1109 and 1113 according to an embodiment.

In a first example, UE 601 may send a multicast reception request 1109 to the network. It aims at notifying the network of its presence and its willing to receive multicast data in RRC_INACTIVE state. The network 602, 603 processes the request 1109 in 1110 in order to send multicast data using MRB2 radio bearer. The request in 1109 may include the MBS session ID, the multicast pre-configuration ID and the G-RNTI, the network may then verify whether the UE in 601 has the authorization to receive multicast data and/or in RRC_INACTIVE state. Following this, multicast data sent in 1111 may be sent to the UE (601) or to the group of candidate UEs in RRC_INACTIVE state.

In a second example, the NG-RAN node in 602 may send multicast data using the multicast pre-configuration exchanged previously with the UE 601. The multicast data in 1112 is then received upon process paging stage in 1107. Later on, the feedback message in 1109 may be sent to inform the NG-RAN node that it is receiving in RRC_INACTIVE state and thus, the NG-RAN node is informed and can continuously multicast the data in RRC_INACTIVE state. The feedback message in 1109 may allow the gNB in 602 to estimate the number of UEs receiving in RRC_INACTIVE state.

In a third example, the UE 601 is not yet pre-configured to receive an RRC_INACTIVE state. Therefore, the paging message in 1106 indicates that as of now, the MBS session is activated. Next, the UE 601 processes the paging in 1107 and may ask to be configured to receive multicast data in RRC_INACTIVE state. Thus, it sends a multicast request in 1109 after interacting with the NG-RAN node 602 in the PRACH procedure 1108. The message in 1109 may request multicast configuration to receive in RRC_INACTIVE state. The request in 1109 may include the MBS session ID, the multicast pre-configuration ID and the G-RNTI, the network may then verify whether the UE in 601 has the authorization to receive multicast data and/or in RRC_INACTIVE state. The network 602, 603 processes the request in 1110 and responds with multicast configuration in 1113 sent back to the UE 601. The network may reject the request of the UE if no authorization is provided.

At the session activation 1104, 1310, the gNB may have pre-configured its UEs and needs to notify them in 1106 and 1315 of the session activation. It may send the configuration to unconfigured UEs in RRC_INACTIVE state as in 1317 and 1113. The gNB may need to update or build the configuration in 1312. The configuration is then sent to the UEs in RRC_INACTIVE state as in 1113 and 1314.

The UE in 601 may perform a simple cell (re) selection 1103 when in an RRC_INACTIVE state. After the multicast MBS session activation 1104 and upon arrival of multicast data 1105, the target NG-RAN node in 900 may send a paging message 1106 with the corresponding multicast MBS session ID (e.g., TMGI), and the paging cause indicating the multicast MBS session activation status. The UE in 601 is then transparent to the target NG-RAN node (900). While processing the paging message in 1107, UE 601 can apply the multicast pre-configuration of the target NG-RAN node 900 if available, i.e., this information element figures in the neighbour cell multicast pre-configuration that could be communicated by the source NG-RAN node in 602 to the UE (601) at the moment of the multicast pre-configuration.

Thereafter, the UE 601 interacts with the target NG-RAN node 900 in the PRACH procedure in 1108. After the PRACH procedure, different scenarios can be envisaged, including but not limited to the examples below.

In a first example, it is considered that the UE 601 has been pre-configured to receive multicast data in the target cell in 1107. Following the PRACH procedure in 1108, the UE 601 may send a multicast reception request in 1109 to activate the multicast reception in RRC_INACTIVE state at the target NG-RAN node 900 if not yet done. The request in 1109 may include the MBS session ID, the multicast configuration ID and the G-RNTI, the network may then verify whether the UE in 601 has the authorization to receive multicast data and/or in RRC_INACTIVE state. After processing the request 1109 in the network in 1110, the target NG-RAN node 900 may redirect the multicast data in 1111 for the UE 601 or the group of candidate UEs able to receive multicast data in RRC_INACTIVE state.

In a second example, it is considered again that the UE 601 has applied a multicast pre-configuration in step 1107 and that the target NG-RAN node 900 is sending the multicast data 1112 through the MRB2 radio bearer and earlier after the paging message 1106. The UE 601 may interact with the target NG-RAN node in 900 (PRACH procedure in 1108) and may send a multicast reception confirmation to the target NG-RAN node 900 as feedback in 1109. The target NG-RAN node processes the confirmation in 1110 and is aware of the presence of UEs receiving in RRC_INACTIVE state. The feedback in 1109 may allow the gNB in 602 to estimate the number of UEs receiving in RRC_INACTIVE state.

In a third example, the UE 601 may request multicast configuration to receive in RRC_INACTIVE state in message 1109. The message in 1109 may include the MBS session ID, the multicast configuration ID and the G-RNTI, the network may then verify whether the UE in 601 has the authorization to receive multicast data and/or in RRC_INACTIVE state. The target NG-RAN node 900 may process the request in 1110 and then, it may send the multicast configuration information 1113 dedicated for RRC_INACTIVE multicast reception if available. After configuring the UE 601 to receive in RRC_INACTIVE state, the target NG-RAN node sends the multicast data as in 1111. The target NG-RAN node 900 may send a reject response to the UE 601 and thus, no possible reception could occur in RRC_INACTIVE state.

The messages in 1109 and 1113 can use the RRC container message or a dedicated SIB message. The container type may not be limited to the RRC or SIB types.

In 1109, the RRC message can be RRCResume Request wherein the message includes additional field depending upon the different scenarios detailed above. The additional field may indicate different reasons as followed:
a multicast reception request to activate the multicast data transmission in RRC_INACTIVE state,
a multicast feedback reception to confirm the presence of UEs receiving multicast data reception in RRC_INACTIVE state,
a multicast configuration request can be inserted in the additional field.

A SIB on demand can be employed also and may take different aspects according to the UE (601) request as listed here.

The message in 1113 is provided by the network 602, 603 and may be sent by RRC message such as RRCResume response or RRCRelease with SuspendConfig or RRCReconfiguration messages. A dedicated SIB can be possible to carry the network response. Other container types not cited here may be used.

The additional field carried in the 1113 message can include the multicast configuration information to receive in RRC_INACTIVE state as a response on multicast configuration request in 1109. It may include a rejection of the configuration request.

The different container types including RRC or SIB messages are exchanged in the context of RRC_INACTIVE state with no required transition to RRC_CONNECTED state. The additional fields type may identify the reason of the message and then, processes accordingly while remaining in RRC_INACTIVE state.

In another implementation, upon the MBS session activation, the first multicast data arriving from the application server to the network may trigger MBS activation message sent by the network to inform the UEs of the session activation. The UE may apply the multicast pre-configuration and multicast data is then received.

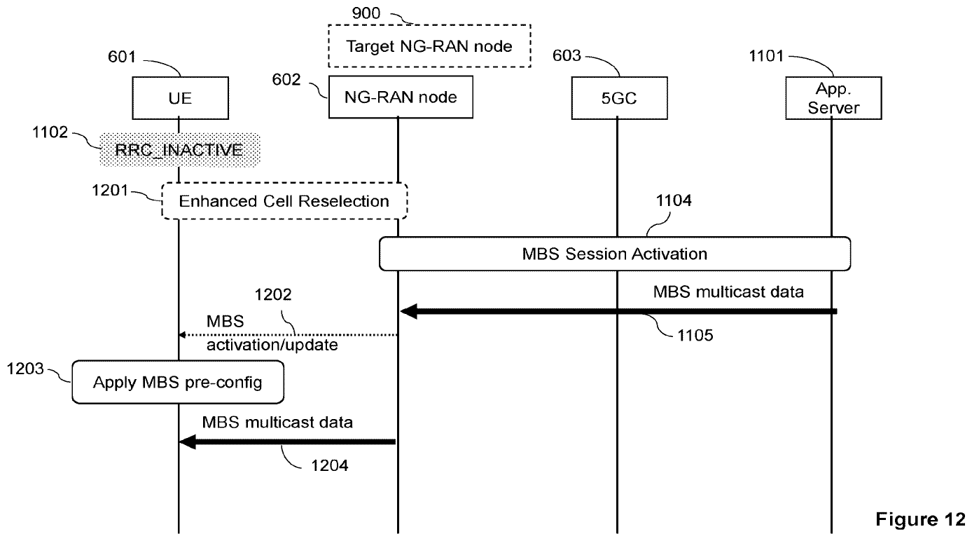

FIG. 12 is a flowchart illustrating the use of the multicast pre-configuration information by the UE after the session is activated, according to an embodiment.

The UE in 601 is in RRC_INACTIVE state 1102. It is assumed that the UE is pre-configured to receive multicast data in RRC_INACTIVE state hereafter. Upon the MBS session activation in 1104, the multicast data in 1105 triggers an MBS activation message 1202, 1408 sent to the candidate UEs capable and pre-configured to receive multicast data in RRC_INACTIVE state. The MBS activation message 1202 may use RRC container as for instance, a paging message with paging cause indicating the session activation or a SIB. The message in 1202 can be associated with a multicast configuration update. Thus, the 1202 message may include an update multicast configuration for the UE in 601 to receive in RRC_INACTIVE state. The multicast configuration update in 1202 is sent via an RRC message.

The UE 601 receives the message in 1202 and applies its multicast pre-configuration in 1203 and 1409. If a configuration change is sent by the network, the UE in 601 may then apply the updated configuration. Thus, the UE receives its first multicast data in 1204 while in RRC_INACTIVE state.

At the multicast session activation 1104, 1310, the gNB may have pre-configured its UEs and need to notify them as in 1202 and 1315 of the multicast session activation. It may send the configuration to unconfigured UEs in RRC_INACTIVE state as in 1317 and 1204. The gNB may need to update or build the configuration as in 1312, which will be described in more detail below with respect to FIG. 13. The configuration is then sent to the UEs in RRC_INACTIVE state as in 1204 of FIG. 12 and 1314 of FIG. 13.

The UE in 601 may perform an enhanced cell (re) selection in 1201 as illustrated in this scenario. In 1201, the enhanced cell (re) selection may involve the NG-RAN nodes 602, 900 in UE context exchange. In 1201, the UE in 601 informs the target NG-RAN node in 900 of its presence. As detailed before, the target NG-RAN node may exchange the UE context with the source NG-RAN node including the UE capability and/or preference to receive in RRC_INACTIVE state by way of example. In another example, the UE may inform the target NG-RAN node 900 of its presence as well as its capability and/or preference without UE context exchange between NG-RAN nodes.

Furthermore, the UE 601 may send additional information related to the multicast configuration ID and/or the G-RNTI to the target gNB 900 during the enhanced cell re-selection procedure 1201. The network may then verify the UE authorization regarding the reception of multicast data and/or in RRC_INACTIVE state.

In case the source NG-RAN node has pre-configured the UE 601 to receive multicast data in RRC_INACTIVE for neighbour cells, the target NG-RAN node is aware of the pre-configuration and will not proceed to pre-configure the UE 601.

In case the UE has to be pre-configured in the target cell, the target NG-RAN node 900 sends its proper multicast pre-configuration information within 1201 or later.

Upon the MBS session activation in 1104, the multicast data in 1105 issued by the application server in 1101 arrive in 1105 to the (target) NG-RAN node 602 or 900. Thereafter, the (target) NG-RAN node sends MBS activation notification in 1202 to the UE 601 before redirecting the multicast data in 1105. In 1203, the UE 601 may apply the multicast pre-configuration received earlier and may begin to receive multicast data 1204 in RRC_INACTIVE state.

The reception of multicast data in the RRC_INACTIVE state may offload the gNB (in other words the gNB will have less load to handle due to the UE being in the RRC_INACTIVE state) and may promote additional UEs joining the MBS session. Thus, it is beneficial to consider the following=for a multicast session, according to an embodiment. The UE may stay in RRC_INACTIVE state when:
at MBS session activation, the UE may apply its (pre) configuration to receive data while staying in the RRC_INACTIVE state,
at MBS deactivation, the UE may stop receiving multicast data, however, the session could be reactivated and later multicast data can be received.

When the MBS session is released, no multicast data will be sent by the network and thus, the UE should return to the RRC_CONNECTED state in order to release the radio resources used for receiving multicast data.

FIG. 13 is a flow chart showing a process executed by a gNB 110 or 111 according to an embodiment. The process of FIG. 13 is applicable to each of the embodiments already describe above. For example, the embodiments described in connection with FIGS. 6 to 12. The execution may be performed by the CPU 315 of the base station shown in FIG. 3, for example.

At step 1300, the gNB receives a UE join request 507, 605 such as that described with respect to previously described FIGS. 5 and 6. Multicast session establishment 523, 606 is triggered by the first join request from a UE. The UE provides PDU session information, the core network provides multicast session information including QoS flow information. Subsequent join requests from UEs to the same multicast session will not trigger new multicast session establishment 523, 606 procedure, however the core network might update the multicast session QoS requirements, for example to manage the load globally in the system.

Then in step 1301 the gNB may decide to perform a radio resources reservation to reserve resources for sending the multicast data to UEs belonging to its cell. It is not mandatory to perform the resource reservation at this step because the multicast data is not yet available, it becomes available later at session activation step 524. Some gNBs might decide to wait on resources reservation until multicast data is available in order to leave radio resources available for other applications while the multicast session is inactive. As stated earlier, there is a risk of overloading the gNB is possible when needing to configure all involved UEs with the radio resources allocated simultaneously. Another risk is to fail the resource allocation because another application would have taken them earlier.

Therefore, in accordance with the embodiments, the gNB will not wait the session activation 524 to perform radio resource reservation, it will perform resource reservation when the number of involved UEs (for example the sum of two lists “unconfigured_connected_ue” plus “unconfigured_inactive_ue”) reached a configurable threshold “max_number_ue_for_simultaneous_configuration”. The threshold is representative of each gNB capacity to handle simultaneous configuration of a large group of UEs.

To manage the UE configuration, the gNB maintains in its memory 325 a set of UE identifier lists per multicast session:
“unconfigured_connected_ue”: UEs in RRC_CONNECTED state that performed the join request,
“unconfigured_inactive_ue”: UEs in RRC_INACTIVE state that performed the join request,
“pre-configured_connected_ue”: UEs in RRC_CONNECTED state that performed the join request that received the pre-configuration information element,
“pre-configured_inactive_ue”: UEs in RRC_INACTIVE state that performed the join request that received the pre-configuration information element,
“configured_connected_ue”: UEs in RRC_CONNECTED state that performed the join request that received the configuration information element,
“configured_inactive_ue”: UEs in RRC_INACTIVE state that performed the join request that received the configuration information element.

The identifier of each UE that performed a join request is stored in the list “unconfigured_connected_ue”.

If the core network sends an updated QoS requirement the gNB will update the UE lists as all previously pre-configured or configured UEs needs updated configuration information:
all UE identifiers in “pre-configured_connected_ue” and “configured_connected_ue” are removed from list and added to “unconfigured_connected_ue”.
all UE identifiers in “pre-configured_inactive_ue” and “configured_inactive_ue” are removed from list and added to “unconfigured_inactive_ue”.

From radio resource reservation, the gNB is able to build a multicast pre-configuration information element. The multicast (pre)-configuration information element may consider different information elements including but not limited to:
multicast Radio Bearer “MRB2” configuration dedicated to receive multicast data with low QoS for candidate UEs, or “MRB1” configuration mainly addressed for UEs in RRC_CONNECTED state with high QoS,
an RRC_INACTIVE reception indication where the gNB indicates to the UEs if they are enabled to receive multicast data in RRC_INACTIVE state. The absence of this indicator means that UE can receive by default multicast data in RRC_INACTIVE state,
G-RNTI identifying a group of UEs within the same cell interested in receiving multicast data,
multicast pre-configuration ID referring to the configuration applied for UEs and associated with the MBS session ID (e.g., TMGI),
discontinuous reception (DRX) configuration used to receive multicast data for candidate UEs,
neighbour cells multicast configuration applied when candidate UEs perform handover or cell re-selection,
cell ID(s) identifying the cell(s) in which the pre-configuration shall be applied.

At step 1302, the gNB sends sequentially the pre-configuration information elements to all UEs “unconfigured_connected_ue” list. The multicast pre-configuration information element can be sent in a RRC configuration message (e.g., FIG. 6). The UE identifiers are removed from the “unconfigured_connected_ue” list and added to the “pre-configured_connected_ue” list.

At step 1303 the gNB will send the pre-configuration information element to UEs in RRC_INACTIVE state (e.g., FIG. 9). The gNB sends a page message 910 to all UEs in the “unconfigured_innactive_ue” and wait for a PRACH procedure 912 from UEs from the list that are still in the gNB's cell (some RRC_IACTIVE UEs may have moved to another cell). Once the PRACH procedure is done, the gNB receives Multicast pre-configuration request messages 913 from the UEs that performed the PRACH procedure. To these UEs the gNB sends a Multicast pre-configuration response message 914 with the multicast pre-configuration information element. In an alternative embodiment (e.g., FIG. 10), UEs apply an enhanced cell re-selection process, like that already described previously, that includes sending a notification to a base station associated with a new cell that may include information indicating which MBS sessions the UE is participating in, so the gNB knows the RRC_INACTIVE UEs in the cell. These UEs have up to date system information and page, PRACH and pre-configuration request can be skipped.

The UE identifiers are removed from the “unconfigured_inactive_ue” list and added to the “pre-configured_inactive_ue” list.

At step 1304 the gNB checks its requests to be a target gNB from a source gNB for the handover of a UE. In handover procedure a source gNB requests to handover the management of a UE to a target gNB. An example of handover is described in FIG. 7. The target gNB knows if the UE had joined the multicast session earlier, this information is part of the hand over information provided by the source gNB.

In step 1305 the target gNB checks if it has already reserved radio resources for the multicast session. If not, then the multicast pre-configuration information element is not ready and the UE identifier corresponding to the handed-over UE is added to the “unconfigured_connected_ue” list.

If multicast pre-configuration information element is available, then during step 1306 the target gNB will send the multicast pre-configuration information element to the handed over UE in a message 708. For example, the message in 708 may be sent in one or multiple RRC messages such as RRCReconfiguration message or dedicated System Information Blocks (SIBs) to the UE in 601.

During step 1307, the gNB may decide to switch some UEs from RRC_CONNECTED state to RRC_INACTIVE state. The goal is to lighten the load of the gNB as described in RP-213568. This is an example implementation of the embodiment described in FIG. 8.

During step 1308 the gNB checks if it has already reserved radio resources for the multicast session. If not, then the multicast pre-configuration information element is not ready and the UE identifiers corresponding to UEs going to change RRC state and that had joined the multicast session are removed from the “unconfigured_connected_ue” list and added to the “unconfigured_inactive_ue”.

If a multicast pre-configuration information element is available, then during step 1309 the gNB sends the multicast pre-configuration information element to the UE in the RRCRelease with SuspendConfig message 807. To this end, the NG-RAN node 602 may use RRCRelease message with SuspendConfig in 807 with an amendment of its content. Additional fields related to the multicast pre-configuration context (information element) can be included and thus, the candidate UE in 601 performs its transition to RRC_INACTIVE state 808 and is aware that by then, it is pre-configured to receive multicast data while remaining in RRC_INACTIVE state.

The gNB cycles back to step 1300 until the multicast session is activated. Then it moves to step 1310.

During step 1310 the gNB receives multicast session activation information 512.

Then during step 1311 the gNB checks whether multicast pre-configuration information element is ready.

If the multicast pre-configuration element is not ready or if the QoS flow information is updated, then in step 1312 the gNB updates or performs the radio resource reservation, the gNB creates or updates the pre-configuration information element. Then the gNB converts the multicast pre-configuration information element in a multicast configuration information element (as described TS 38.331).

Then during step 1313 the gNB will send the multicast configuration information element to all UEs in “unconfigured_connected_ue” and “pre-configured_connected_ue” and “configured_connected_ue” lists. Similar to step 1302, the multicast configuration information element is sent in an RRCReconfiguration message. All UE identifiers of “unconfigured_connected_ue” and “pre-configured_connected_ue” are moved to “configured_connected_ue” list.

Then during step 1314 (e.g., FIG. 11), the gNB sends a page message with paging cause set to “MBS session activation” (like suggested in TR23.700-47). Then UEs that are present in the cell, that are in RRC_INACTIVE state and that had joined the multicast session will perform a PRACH procedure to update their system information, then the UEs will send a Multicast MBS configuration request message (MBSConfigurationRequest or MBSConfigurationRequest1). The MBS configuration request message may be a new RRC message or a RRCResumeRequest message or a System Information Block (SIB) reception request. The multicast MBS configuration request message may include an identifier for identifying the activated multicast session (e.g., MBS session id and/or Temporary Mobile Group Identity (TMGI)). In other words, an identifier for indicating the MBS session the configuration is requested for. In addition, the multicast MBS configuration request message may include UE identity information for identifying the UE 101, such as IMSI, IMEI, and/or Authentication information (ueMAC-I), such as an authentication token, for use in authenticating the UE 101. Upon reception of the multicast MBS configuration request message, the gNB will send an MBS configuration message (MBSConfiguration) with the multicast configuration information element to the UE. The multicast MBS configuration request message which may include gathering or obtaining the necessary information to build the UE configuration for the at least one UE so the at least one UE can receive multicast data for the activated multicast session. Once the UE configuration is known (including the step of Radio Access Network (RAN) resource reservation), the base station or gNB 111 sends a multicast MBS configuration message to the at least one UE. The multicast MBS configuration message includes configuration information for configuring the at least one UE for reception of multicast data in a non-connected RRC state, such as RRC_INACTIVE state, for the activated multicast session. In an example, the configuration information includes configuration information of at least one Multicast Radio Bearer, MRB (e.g., configuration of at least one MRB to be used by the gNB 111 and the at least one UE 101 for communication of the multicast data for the activated multicast session). It is noted that one or more MRBs can be associated to one MBS session. The MRB configuration information may include Packet Data Convergence Protocol (PDCP) and Service Data Adaptation Protocol (SDAP) setup information.

The MBS configuration message is sent to the at least one UE by the base station (e.g., source or serving base station) controlling the cell where the UE is camped and is sent in response to receiving the MBS configuration request message from the at least one UE. The MBS configuration message may be a RRCReconfiguration message or a RRCRelease with suspend configuration message or a RRCResume message or a SIB message.

Further details of the multicast configuration request message and multicast MBS configuration message can be found in United Kingdom patent application number GB2210307.1. In an alternative embodiment, UEs apply the enhanced cell re-selection process as previously described, so the gNB knows the RRC_INACTIVE UEs in the cell, these UEs have up to date system information and the page, PRACH and pre-configuration request can be skipped.

Each time a UE sends a Multicast Configuration Request Message the gNB adds the corresponding UE identifier to the “configured_inactive_ue” list and removes it from “unconfigured_inactive_ue” and “pre-configured_inactive_ue” list if it is present.

Back to step 1311, if the multicast configuration information element is ready and the QoS flow information is not changed, then during step 1315 the gNB sends a page message with paging cause set to “apply pre-configuration” to all UE identifiers present in “pre-configured_connected_ue” and “pre-configured_inactive_ue” lists. So, all UEs that had previously received the multicast pre-configuration information element will be able to apply this configuration and receive the multicast data. Then all UE identifiers are removed from “pre-configured_connected_ue” and added to “configured_connected_ue”. Similarly, all UE identifiers are removed from “pre-configured_inactive_ue” and added to “configured_inactive_ue”.

Then the gNB will configure the UEs that had remained unconfigured as reflected in “unconfigured_inactive_ue” and “unconfigured_connected_ue”. The gNB converts the Multicast pre-configuration information element to a multicast configuration information element.

During step 1316 the gNB will send the multicast configuration information element to all UEs in “unconfigured_connected_ue”. Similar to step 1302, the multicast configuration information element is sent in an RRCReconfiguration message. All UE identifiers of “unconfigured_connected_ue” are moved to “configured_connected_ue” list.

Then during step 1317, the gNB sends a page message with paging cause set to “MBS session activation” (as suggested in TR23.700-47). Then UEs that are present in the cell, that are in RRC_INACTIVE state and that had joined the multicast session and have not a pre-configuration information element will perform a PRACH procedure to update their system information, then the UEs will send a Multicast configuration request message (MBSConfigurationRequest or MBSConfigurationRequest1) and the gNB will send a MBS configuration message (MBSConfiguration) with the multicast configuration information element. Further details of the multicast configuration request message and MBS configuration message can be found as described previously herein and in United Kingdom patent application number GB2210307.1. In an alternative embodiment, UEs apply cell re-selection process conform to the enhanced cell re-selection process already described above, so the gNB knows the RRC_INACTIVE UEs in the cell, these UEs have up to date system information and page, PRACH and pre-configuration request can be skipped.

Each time a UE sends a Multicast Configuration Request Message the gNB adds the corresponding UE identifier to the “configured_inactive_ue” list and removes it from “unconfigured_inactive_ue” list if it is present.

Once the multicast session is activated the gNB behaves as described in TS 23.247.

FIG. 14 is a flow chart showing a process performed by a UE 101 according to an embodiment. Similar to FIG. 13, the process shown in the flowchart of FIG. 14 is applicable to each of the embodiments already described above. For example, the embodiments described in connection with FIGS. 6 to 12. The execution may be performed by the CPU 215, for example.

First at step 1400 the UE is in RRC_CONNECTED state, it performs a join procedure 523, 605 to join a multicast session.

Next during step 1401, the UE waits a multicast pre-configuration message (including multicast pre-configuration information) from the gNB. The multicast pre-configuration message can be sent by the gNB as a modified RRCReconfiguration message at step 1302 (e.g. FIG. 6), or at step 1306 after a handover procedure (e.g., FIG. 7), or a step 1309 as part a modified RRCRelease message with SuspendConfig. If a multicast pre-configuration information element is received, then the UE stores it in the memory 225.

If the UE is still in RRC_CONNECTED state then test 1402 indicates no offload.

If the UE is now in RRC_INACTIVE state after having received either a standard RRCRelease message or a modified RRCRelease message, the test 1402 indicated offload.

If the UE is in RRC_INACTIVE state (1402 indicates yes), then during step 1403, the UE waits the reception of a multicast pre-configuration message from the gNB. The multicast pre-configuration message can be sent by the gNB at step 1303 (e.g., FIG. 9). At step 1303 the gNB sends a page message 910 with multicast pre-configuration cause, then UE initiates a PRACH procedure and send a Multicast pre-configuration request messages 913 to the gNB. Then the gNB sends back a Multicast pre-configuration response message 914 with the multicast pre-configuration information element. In an alternative embodiment (e.g., FIG. 10), UEs apply cell re-selection process conforming to the enhanced cell re-selection process already described above, so the gNB knows the RRC_INACTIVE UEs in the cell, these UEs have up to date system information and page, PRACH and pre-configuration request can be skipped.

When the UE is in RRC_INACTIVE state it cycles back to step 1403 until the multicast (MBS) session is activated at step 1404. When the multicast session is activated in 1404, the UE may have or may not have a multicast session pre-configuration information element stored in the memory 225.

In step 1405, the UE waits for a page message from the gNB (step 1315) with “apply pre-configuration” paging cause. If the page is received then during test 1406, the UE checks if it got a multicast pre-configuration information element stored in memory 225. If yes, then during step 1407 the UE applies the relevant configuration from the pre-configuration information and is now able to receive the multicast data.

If the UE does not have a stored pre-configuration then it cycles back to step 1405.

Back to step 1405, if the received page message does not include the “apply pre-configuration” paging cause, then during test 1408, the UE checks for the “MBS session activation” paging cause.

If the “MBS session activation” paging cause is not included in the page message then the UE cycles back to step 1405, waiting for a new page message.

If the “MBS session activation” paging cause is included, then during step 1409, the UE will request the multicast configuration information element from the gNB even if it already got a stored pre-configuration (the configuration have been updated at gNB side, the UE stored pre-configuration is obsolete).

The gNB sends the “MBS session activation” paging cause at step 1314 or 1317 (corresponding to FIG. 11), the gNB sends a page message with paging cause set to “MBS session activation” (like suggested in TR23.700-47). Then UE performs a PRACH procedure to update its system information, then the UE will send a Multicast configuration request message (MBSConfigurationRequest or MBSConfigurationRequest1) and the gNB will send an MBS configuration message (MBSConfiguration) with the multicast configuration information element. Further details of the multicast configuration request message and MBS configuration message can be found as described previously herein and in United Kingdom patent application number GB2210307.1. In an alternative embodiment, UE apply cell re-selection process conform to the enhanced cell re-selection process already described above, so the gNB knows the RRC_INACTIVE UEs in the cell, these UEs have up to date system information and page, PRACH and pre-configuration request can be skipped.

Once it receives the MBS configuration message, the UE applies the configuration and it is ready to receive the multicast data.

That concludes the RRC_INACTIVE part. Back to the RRC_CONNECTED part (‘no’ to condition tested in 1402),

When the UE is in RRC_CONNECTED state it cycles back to step 1401 until the MBS session is activated at step 1410. When the multicast session is activated in 1410, the UE may have or may not have a multicast session pre-configuration information element stored in the memory 225.

In step 1411, the UE waits a page message from the gNB (step 1315) with “apply pre-configuration” paging cause. If the page is received then during test 1412, the UE checks if it got a multicast pre-configuration information element stored in memory 225. If yes, then during step 1413 the UE applies the relevant configuration from the pre-configuration information and is now able to receive the multicast data.

If the UE does not have a stored pre-configuration then it cycles back to 1411.

At 1411, if the received page does not include the “apply pre-configuration” paging cause, then during test 1414, the UE checks for the reception of a standard RRCReconfiguration message from the gNB.

If the RRCReconfiguration message is not received then the UE cycles back to step 1411, waiting for a new page or RRC message.

If the RRCReconfiguration message is received, then during step 1415, the UE will apply the configuration as received even if it already got a stored pre-configuration (the configuration has been updated at gNB side, the UE stored pre-configuration is obsolete).

The gNB sends the RRCReconfiguration message at step 1316 or 1313.

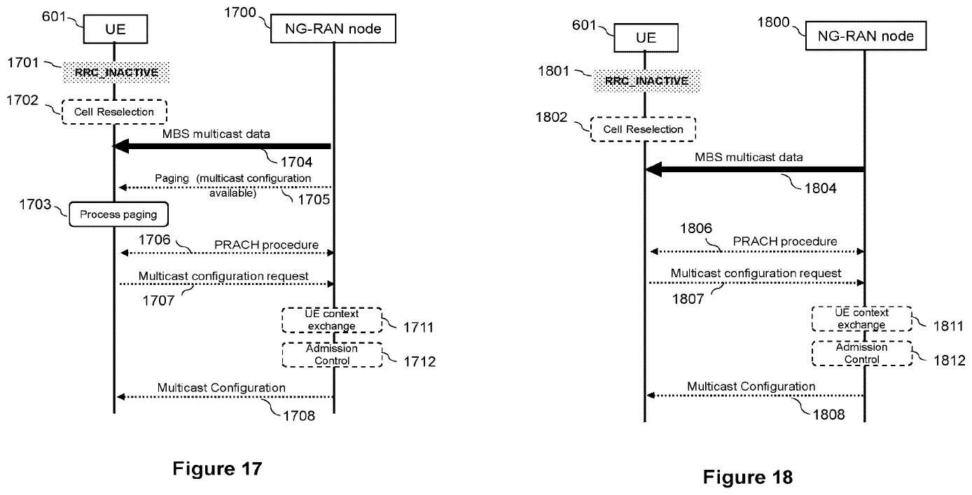

An update of configuration procedure, according to an embodiment of the invention, will now be described with reference to FIGS. 17 and 18. FIG. 17 is a flow chart illustrating the update of configuration initiated by the network for UEs in RRC_INACTIVE state according to an embodiment.

FIG. 17 shows a UE in 601 having joined the multicast MBS session in 605 while in RRC_CONNECTED state 604 (as shown in FIG. 6), and that has been switched by the network to the RRC_INACTIVE state at step 1701.

The UE 601 continuously performs the cell re-selection process 1702 to search for the best cell to camp. While moving the UE may have switched cell several times since it is in RRC_INACTIVE state. It is noted that the cell reselection processes 1702, 1802 represent optional steps in the methods shown in FIGS. 17 and 18, as denoted by the dashed outline. In each of these methods the cell reselection step may be replaced by a configuration update of the base station (e.g., NG-RAN node 1700) which may be caused, for example, by resetting the base station following a detected fault.

At the same time, the multicast MBS session has been activated and the NG-RAN node 1700 is transmitting the multicast data 1704 in the cell where the UE 601 is now camping. It is assumed that the UE 601 has obtained the multicast configuration to be able to receive the multicast data in this cell, for instance, before the MBS session activation using the method of FIG. 9 or according to any of the other preceding embodiments where (pre-) configuration information is received before MBS session activation. Alternatively, the initial configuration information obtained by the UE 601 may have been received after the MBS session activation (for instance, using the method of FIGS. 5a and 5b). The NG-RAN node 1700 controlling the cell where the UE 601 is camping may not be aware of the presence of the UE 601 in the cell controlled by the NG-RAN node 1700.

In a case where the NG-RAN node 1700 has detected that a modification of the multicast configuration is necessary to receive multicast data in the cell(s) it controls in the MBS service area, or if the NG-RAN node 1700 has been notified of a modification of the multicast configuration in cell(s) controlled by another NG-RAN node, then the NG-RAN node 1700 may initiate an update of the multicast configuration for the UEs interested in receiving the corresponding MBS session. For the UEs in RRC_CONNECTED state, the NG-RAN 1700 will use a RRCReconfiguration message to provide the update. For the UEs in RRC_INACTIVE state, the NG-RAN node 1700 may first send a notification 1705 in the cell(s) it controls in the MBS service area. This notification may be a group paging message indicating the multicast session id and indicating that the purpose is the availability of multicast configuration(s).

The UE 601 receiving the notification 1705 will process the provided information at step 1703. If the multicast session ID corresponds to the session the UE 601 is interested in, the UE 601 executes a PRACH exchange procedure 1706 with the NG-RAN node 1700. In 1706, the UE 601 communicates its UE identity with the NG-RAN node and requests uplink radio resources for L2/L3 messages and RRC connection messages. Next, the UE 601 sends a multicast configuration request message 1707 to the NG-RAN node 1700. The message 1707 may be a RRC Resume Request (specified in TS 38.331) including the multicast session ID and indicating that the request for reception of multicast configuration(s). This message also includes the identification of the UE in RRC_INACTIVE state (i.e., I-RNTI) and the identification of the NG-RAN node that set the UE 601 in RRC_INACTIVE state and allocated the I-RNTI to the UE 601.

The NG-RAN node 1700 verifies that the UE has joined the MBS session and it is authorized to receive the associated multicast data. For this purpose, the NG-RAN node 1700 will perform the UE context exchange procedure 1711 with the NG-RAN that set the UE 601 in RRC_INACTIVE state, to retrieve the context of the UE 601. Then, the NG-RAN node 1700 executes the admission control step 1712 to verify that the UE 601 is allowed to receive the multicast data according to the received UE context. If the request of UE 601 is accepted, the NG-RAN node sends multicast configuration(s) within the message 1708 to the UE 601. The target NG-RAN node may reject the request while indicating the reject cause.

The multicast configuration message 1708 may be the RRC Release with SuspendConfig message (specified in TS 38.331) and containing one or several multicast configurations to be used in one or several cells in the neighbourhood. A multicast configuration may be identified by a multicast configuration ID. A mapping between the multicast configuration ID and the cell identity where the multicast configuration can be applied shall be provided to the UE.

In order to avoid the steps 1711 and 1712, the UE may include in the request message 1707 the G-RNTI it is using to decode the received multicast data. By providing this G-RNTI the NG-RAN node 1700 can assess that the UE 601 is an authorized UE and the NG-RAN 1700 can provide the multicast configurations.

During all the procedure described at the FIG. 17, the UE 601 can remain in RRC_INACTIVE state and can continue receiving the multicast data.

FIG. 18 is a flow chart illustrating the sending of configuration requested by a UE in RRC_INACTIVE state according to an embodiment.

FIG. 18 shows a UE in 601 having joined the multicast MBS session in 605 while in RRC_CONNECTED state 604, and that has been switched by the network to the RRC_INACTIVE state at step 1801.

The UE 601 continuously performs the cell re-selection process 1802 to search for the best cell to camp. While moving the UE may have switched cell several times since it is in RRC_INACTIVE state.

At the same time, the multicast MBS session has been activated and the NG-RAN node 1800 is transmitting the multicast data 1804 in the cell where the UE 601 is now camping. It is assumed that the UE 601 has obtained the multicast configuration to be able to receive the multicast data in this cell, for instance, before the MBS session activation using the method of FIG. 9 or according to any of the other preceding embodiments where (pre-) configuration information is received before MBS session activation. The NG-RAN node 1800 controlling the cell where the UE 601 is camping may not be aware of the presence of the UE 601 in the cell controlled by the NG-RAN node 1800.

When performing the cell re-selection process 1802, the UE 601 may detect one or several cells in the MBS service area for which the UE 601 does not have the multicast configuration to receive the multicast data in RRC_INACTIVE state.

The UE 601 may then request the missing multicast configuration(s) to the NG-RAN node 1800. For this purpose, the UE 601 executes a PRACH exchange procedure 1806 with the NG-RAN node 1800. In 1806, the UE 601 communicate its UE identity with the NG-RAN node and requests uplink radio resources for L2/L3 messages and RRC connection messages. Next, the UE 601 sends a multicast configuration request message 1807 to the NG-RAN node 1800. The message 1807 may be a RRC Resume Request (specified in TS 38.331) including the multicast session ID and indicating that the request for reception of multicast configuration(s), and indicating the identity of the cell(s) for which the multicast configuration(s) is/are requested. This message also includes the identification of the UE in RRC_INACTIVE state (i.e., I-RNTI) and the identification of the NG-RAN node that set the UE 601 in RRC_INACTIVE state and allocated the I-RNTI to the UE 601.

The NG-RAN node 1800 verifies that the UE has joined the MBS session and it is authorized to receive the associated multicast data. For this purpose, the NG-RAN node 1800 will perform the UE context exchange procedure 1811 with the NG-RAN that set the UE 601 in RRC_INACTIVE state, to retrieve the context of the UE 601. Then, the NG-RAN node 1800 executes the admission control step 1812 to verify that the UE 601 is allowed to receive the multicast data according to the received UE context. If the request of UE 601 is accepted, the NG-RAN node sends the requested multicast configuration(s) within the message 1808 to the UE 601. The target NG-RAN node may reject the request while indicating the reject cause.

If the NG-RAN node 1800 does not have a multicast configuration, it may request them to the NG-RAN node(s) controlling the cell(s) for which the UE 601 requested the multicast configuration. Such information may be performed through the exchange Xn protocol messages.

The multicast configuration message 1808 may be the RRC Release with SuspendConfig message (specified in TS 38.331) and containing the requested multicast configuration(s), at least for the multicast configuration known at the NG-RAN node 1800.

In order to avoid the steps 1811 and 1812, the UE 601 may include in the request message 1807 the G-RNTI it is using to decode the received multicast data. By providing this G-RNTI the NG-RAN node 1800 can assess that the UE 601 is an authorized UE and the NG-RAN 1800 can provide the multicast configurations.

During all the procedure described at the FIG. 18, the UE 601 can remain in RRC_INACTIVE state and can continue receiving the multicast data.

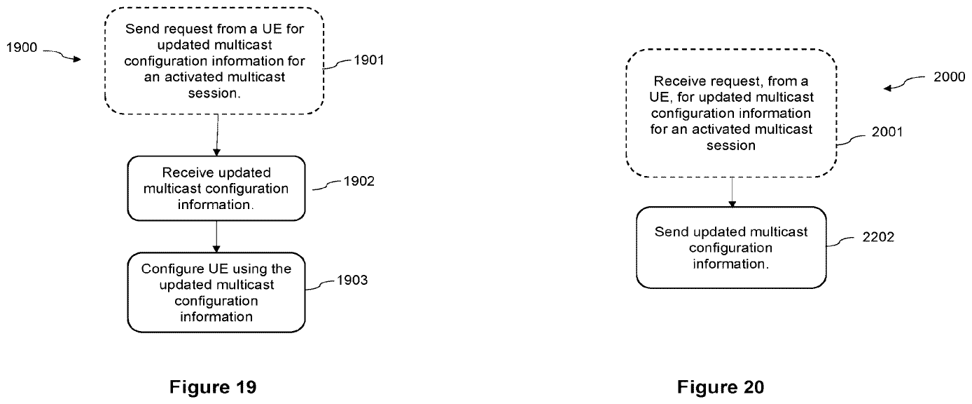

An exemplary method of controlling a UE (e.g., 601) and/or a base station (e.g., NG-RAN 1700, 1800) of a wireless network (e.g., according to the update of configuration procedures shown in FIGS. 17 and 18), will now be described with reference to FIGS. 19 and 20. FIG. 19 shows a flowchart 1900 which is performed at a UE, whereas FIG. 20 shows a flowchart 2000 having steps performed at a base station, according to an embodiment of the invention. For each of the methods shown in FIGS. 19 and 20, the UE has previously received (initial or old) multicast data corresponding to an activated multicast session, but a subsequent change to the network means that a modification of the UE's (e.g., initial, or previous) multicast configuration (e.g., based on multicast configuration information that has previously been obtained by the UE) is required. The initial multicast configuration may be obtained before session establishment whilst the UE is in the RRC_CONNECTED state (as shown in FIGS. 6 and 7), or whilst the UE is in an RRC_INACTIVE state (as shown in FIGS. 8 and 9). Alternatively, the previous configuration may be obtained after session establishment whilst the UE is in an RRC_INACTIVE (as shown in FIGS. 10a, 10b, and 11).

At step 1901, the UE is in a non-connected RRC (e.g., RRC_INACTIVE) state, and sends a request to a base station for (updated or new) multicast configuration information of the activated multicast session. At step 2001, the base station receives the request for the (updated or new) multicast configuration information from the UE in a non-connected RRC state (e.g., as shown in steps 1707, 1807 of FIGS. 17 and 18). At step 2202, the base station sends the (updated or new) multicast configuration information which is received by the UE at step 1902 (e.g., as shown in steps 1708, 1808 of FIGS. 17 and 18). In step 1903, the UE is configured according to the (updated) multicast configuration information that it received from the base station. Advantageously, this method provides updated multicast configuration information to the UE (e.g., following a cell reselection procedure), which enables the UE to continue receiving multicast data from the activated multicast session whilst remaining in a non-connected RRC state throughout.

The following provides details of an example procedure for configuring a UE for multicast reception with reference to sections and clauses of TS 38.331 version 17.0.0. The MBSPreConfiguration corresponds to the multicast (MBS) pre-configuration information discussed above.

The purpose of this procedure is to allow for sending of pre-configuration data to a UE prior to session activation which can be used to subsequently configure the UE to receive multicast data from a base station in a network. The pre-configuration, multicast reception procedure, and multicast reception request procedure is described below and shall have a definitive numbering later, for the moment they are each referred to by the numbering 5.3.X. An implementation of the MBSConfigurationRequest, MBSConfigurationRequest1 and MBSConfiguration request messages, referred to in certain embodiments above, is described in detail below.

### 5.3.2.3 Reception of the Paging Message by the UE

1> for each TMG/included in pagingGroupList, if any, included in the Paging message:
2> if the UE has joined an MBS session indicated by the TMGI included in the pagingGroupList:
   3> forward the TMGI to the upper layers;
      1> if in RRC_INACTIVE and the UE has joined one or more MBS session(s) indicated by the TMGI included in the pagingGroupList; and
      1> if none of the ue-Identity included in any of the PagingRecord, if included in the Paging message, matches the UE identity allocated by upper layers:
2> If MBS_session activation is included in the paging cause
   3> Initiate the RRC_INACTIVE multicast reception procedure according to 5.3.X (e.g., as discussed with reference to FIGS. 6-10 and/or discussed below in the discussion of an example procedure for configuring a UE for multicast reception with reference to sections and clauses of TS 38.331 version 17.0.0)
2> Else, initiate the RRC connection resumption procedure according to 5.3.13 with resumeCause set as below:
   3> if the UE is configured by upper layers with Access Identity 1:
      4> resumeCause is set to mps-PriorityAccess;
   3> else if the UE is configured by upper layers with Access Identity 2:
      4> resumeCause is set to mcs-PriorityAccess;
   3> else if the UE is configured by upper layers with one or more Access Identities equal to 11-15:
      4> resumeCause is set to highPriorityAccess;
   3> else:
      4> resumeCause is set to mt-Access.
2> If multicast pre-configuration is included in the paging cause
2> Initiate the RRC_INACTIVE pre-configuration request
2> Else, initiate the RRC connection resumption procedure according to 5.3.13 with resumeCause set as below:
   3> if the UE is configured by upper layers with Access Identity 1:
      4> resumeCause is set to mps-PriorityAccess;
   3> else if the UE is configured by upper layers with Access Identity 2:
      4> resumeCause is set to mcs-PriorityAccess;
   3> else if the UE is configured by upper layers with one or more Access Identities equal to 11-15:
      4> resumeCause is set to highPriorityAccess;
   3> else:
      4> resumeCause is set to mt-Access.

### 5.3.X Multicast Pre-Configuration Request Procedure

### 5.3.X.1 General

Figure 5.3.X. 1-1 Multicast pre-configuration request

The purpose of this procedure is to setup multicast reception in RRC_INACTIVE state, including multicast MRB(s).

### 5.3.X.2 Initiation

The UE initiates the procedure when upper layers or AS (when responding to RAN paging) requests the reception of Multicast in RRC_INNACTIVE state.

The UE shall ensure having valid and up to date essential system information as specified in clause 5.2.2.2 before initiating this procedure.

Upon initiation of the procedure, the UE shall:

1> if the resumption of the RRC connection is triggered by response to NG-RAN paging:
2> select ‘0’ as the Access Category;
2> perform the unified access control procedure as specified in 5.3.14 using the selected Access Category and one or more Access Identities provided by upper layers;
   3> if the access attempt is barred, the procedure ends;
      5.3.X.3 Actions related to transmission of MBSPreConfigRequest or MBSPreConfigRequest1 message

The UE shall set the contents of MBSPreConfigRequest message.

### 5.3.X.4 Reception of the MBSPreConfiguration by the UE

The UE shall:

1> if the RRCResume includes the radioBearerConfig:
2> perform the radio bearer configuration according to 5.3.5.6;

### 6.2.2 Message Definitions

MBSPreConfigRequest

The MBSPreConfigRequest message is used to request the pre-configuration for the reception of multicast in RRC_INACTIVE state.
Signalling radio bearer: SRB0
RLC-SAP: TM
Logical channel: CCCH
Direction: UE to Network
MBSPreConfigurationRequest message

-- ASN1START
-- TAG-MBSPreCONFIGURATIONREQUEST-START

| | |
|---|---|
| MBSPreConfigurationRequest::= | SEQUENCE |
| {mbsPreConfigurationRequest | MBSPreCconfigurationRequest-IEs} |

MBSPreConfigurationRequest-IEs ::= SEQUENCE

| | |
|---|---|
| {ueIdentity | ShortI-RNTI-Value, |
| ueMAC-I | BIT STRING (SIZE (16)), |
| multicastSessionId | MulticastSessionId, |
| G-RNTI-r17 | RNTI-value OPTIONAL |
| spare | BIT STRING (SIZE (1))} |

-- TAG-MBSPreCONFIGURATIONREQUEST-STOP
-- ASN1STOP

MBSPreConfigurationRequest-IEs field descriptions

```
  multicastSessionId
  Indicates which MBS session the pre-configuration is requested for
  ueIdentity
  UE identity to facilitate UE context retrieval at gNB.
  ueMAC-I
  Authentication token to facilitate UE authentication at gNB. The 16
least significant bits of the MAC-I calculated using the AS security
configuration as specified in 5.3.13.3.
  G-RNTI
  The group ID of multiple UEs receiving in PTM mode
```

MBSPreConfiguration

The MBSPreConfiguration message is used to setup the reception of multicast in RRC_INACTIVE state.
Signalling radio bearer: SRB1
RLC-SAP: AM
Logical channel: DCCH
Direction: Network to UE
MBSPreConfiguration message

-- ASN1START
-- TAG-MBSPreCONFIGURE-START

| | |
|---|---|
| MBSPreConfigure ::= | SEQUENCE |
| {rrc-TransactionIdentifier | RRC-TransactionIdentifier, |
| criticalExtensions | CHOICE |
| {MBSPreConfigure | MBSPreConfigure-IEs, |
| criticalExtensionsFuture | SEQUENCE { }}} |
| MBSPreConfigure-IEs ::= | SEQUENCE |
| {radioBearerConfig | RadioBearerConfig OPTIONAL, -- Need |
| MBS-DRX-PreConfig | MBS-DRX-Config |

OPTIONAL,

| | |
|---|---|
| Multicast pre-configuration identity | Multicast pre-configuration identity |

OPTIONAL

| | | |
|---|---|---|
| G-RNTI-r17 | RNTI-value | OPTIONAL |
| RRC_INACTIVE-reception-Indicator | Boolean | OPTIONAL} |

| | |
|---|---|
| MBSPreConfigure1-IEs ::= | SEQUENCE |
| {CellIndentity | Cell Indentity, |
| radioBearerConfig | RadioBearerConfig OPTIONAL, -- Need M |
| MBS-DRX-PreConfig | MBS-DRX-Config |

OPTIONAL,

| | |
|---|---|
| Multicast pre-configuration identity | Multicast pre-configuration identity |

OPTIONAL

| | | |
|---|---|---|
| G-RNTI-r17 | RNTI-value | OPTIONAL |
| RRC_INACTIVE-reception-Indicator | Boolean | OPTIONAL} |

-- TAG-MBSPreConfigure-STOP
-- ASN1STOP

RRCResume-IEs field descriptions

radioBearerConfig
Configuration of Radio Bearer2 (MRB2) including SDAP/PDCP.
MBS-DRX-PreConfig
DRX configuration to receive multicast data
Cell Identity
The neighbour cell identity
Multicast preconfiguration identity
The multicast pre-configuration identity associated to an MBS
session identity
G-RNTI
The group ID of multiple UEs receiving in PTM mode
RRC_INACTIVE reception indicator- optional
RRC_INACTIVE multicast reception - Boolean

MBSPreConfiguration message

RRCRelease-v1650-IEs ::= SEQUENCE

| | |
|---|---|
| {mpsPriorityIndication-r16 | ENUMERATED {true} OPTIONAL, -- Cond Redirection2 |
| radioBearerConfig | RadioBearerConfig OPTIONAL, -- Need M |
| MBS-DRX-PreConfig | MBS-DRX-Config |

OPTIONAL,

| | |
|---|---|
| MBSPreConfigure1-IEs ::= | SEQUENCE |
| {CellIndentity | Cell Indentity, |
| radioBearerConfig | RadioBearerConfig OPTIONAL, -- Need M |
| MBS-DRX-PreConfig | MBS-DRX-Config |

OPTIONAL,

| | |
|---|---|
| Multicast pre-configuration identity | Multicast pre-configuration identity |

OPTIONAL

| | | |
|---|---|---|
| G-RNTI-r17 | RNTI-value | OPTIONAL |
| RRC_INACTIVE-reception-Indicator | Boolean | OPTIONAL}} |

RRCRelease-IEs field descriptions

With Suspend Config:
radioBearerConfig
Configuration of Radio Bearer2 (MRB2) including SDAP/PDCP.
MBS-DRX-PreConfig
DRX configuration to receive multicast data
Cell Identity
The neighbour cell identity
Multicast preconfiguration identity
The multicast pre-configuration identity associated to an MBS
session identity
G-RNTI
The group ID of multiple UEs receiving in PTM mode
RRC_INACTIVE reception indicator- optional
RRC_INACTIVE multicast reception - Boolean

### 5.3.X Multicast Reception Procedure

### 5.3.X.1 General

Figure 5.3.X. 1-1 Multicast reception request

The purpose of this procedure is to setup multicast reception in RRC_INACTIVE state, including multicast MRB(s).

### 5.3.X.2 Initiation

The UE initiates the procedure when upper layers or AS (when responding to RAN paging) requests the reception of Multicast in RRC_INACTIVE state.

The UE shall ensure having valid and up to date essential system information as specified in clause 5.2.2.2 before initiating this procedure.

Upon initiation of the procedure, the UE shall:

1> if the resumption of the RRC connection is triggered by response to NG-RAN paging:
2> select ‘0’ as the Access Category;
2> perform the unified access control procedure as specified in 5.3.14 using the selected Access Category and one or more Access Identities provided by upper layers;
   3> if the access attempt is barred, the procedure ends;
      Actions related to transmission of MBSConfigRequest or MBSConfigRequest1 message
      The UE shall set the contents of MBSConfigRequest or MBSConfigRequest1 message as follows:
      1> if field useFullResumeID is signalled in SIB1:
2> select MBSConfigRequest1 as the message to use;
2> set the ueldentity to the stored fulll-RNTI value;
   1> else:
2> select MBSConfigRequest as the message to use;
2> set the ueldentity to the stored shortl-RNTI value;
   1> re-establish PDCP entities for SRB1;
   1> resume SRB1;
   1> submit the selected message MBSConfigRequest or MBSConfigRequest1 for transmission to lower layers.

### Reception of the MBSConfiguration by the UE

The UE shall:

1> if the RRCResume includes the radioBearerConfig:
2> perform the radio bearer configuration according to 5.3.5.6;

### Message Definitions

MBSConfigRequest

The MBSConfigRequest message is used to request the configuration for the reception of multicast in RRC_INACTIVE state.

Signalling radio bearer: SRB0
RLC-SAP: TM
Logical channel: CCCH
Direction: UE to Network
   MBSConfigurationRequest message

-- ASN1START
-- TAG-MBSCONFIGURATIONREQUEST-START

| | |
|---|---|
| MBSConfigurationRequest ::= | SEQUENCE |
| {mbsRConfigurationRequest | MBSCconfigurationRequest-IEs} |
| MBSConfigurationRequest-IEs ::= | SEQUENCE |
| { ueIdentity | ShortI-RNTI-Value, |
| ueMAC-I | BIT STRING (SIZE (16)), |
| multicastSessionId | MulticastSessionId, |
| spare | BIT STRING (SIZE (1))} |

-- TAG-MBSCONFIGURATIONREQUEST-STOP
-- ASN1STOP

MBSConfigurationRequest-IEs field descriptions

```
  multicastSessionId
  ueIdentity
  UE identity to facilitate UE context retrieval at gNB.
  ueMAC-I
  Authentication token to facilitate UE authentication at gNB. The 16
least significant bits of the MAC-I calculated using the AS security
configuration as specified in 5.3.13.3.
```

Mbsconfigurationrequest1

The MBSConfigurationRequest1 message is used to request the configuration for the reception of multicast in RRC_INACTIVE state.
Signalling radio bearer: SRB0
RLC-SAP: TM
Logical channel: CCCH1
Direction: UE to Network
   MBSConfigurationRequest1 message

-- ASN1START
-- TAG-MBSCONFIGURATIONREQUEST1-START

| | |
|---|---|
| MBSConfigrationRequest1 ::= | SEQUENCE |
| {mbsConfigurationRequest1 | MBSConfigurationRequest1-IEs} |
| MBSConfigurationRequest1-IEs ::= | SEQUENCE |
| {ueIdentity | I-RNTI-Value, |
| ueMAC-I | BIT STRING (SIZE (16)), |
| multicastSessionId | TMGI-R17, |
| spare | BIT STRING (SIZE (1))} |

-- TAG-MBSCONFIGURATIONREQUEST1-STOP
-- ASN1STOP

MBSConfigurationRequest1-IEs field descriptions

```
  multicastSessionId
  Indicates which MBS session the configuration is requested for.
  ueIdentity
  UE identity to facilitate UE context retrieval at gNB.
  ueMAC-I
  Authentication token to facilitate UE authentication at gNB. The 16
least significant bits of the MAC-I calculated using the AS security
configuration as specified in 5.3.13.3.
```

MBSConfiguration

The MBSConfiguration message is used to setup the reception of multicast in RRC_INACTIVE state.
Signalling radio bearer: SRB1
RLC-SAP: AM
Logical channel: DCCH Direction: Network to UE
   MBSConfiguration message

| -- ASN1START | |
|---|---|
| -- TAG-MBSCONFIGURE-START | |
| MBSConfigure ::= | SEQUENCE |
| {rrc-TransactionIdentifier | RRC-TransactionIdentifier, |
| criticalExtensions | CHOICE |
| {MBSConfigure | MBSConfigure-IEs, |
| criticalExtensionsFuture | SEQUENCE { }}} |
| MBSConfigure-IEs ::= | SEQUENCE |
| { radioBearerConfig | RadioBearerConfig |
| OPTIONAL, | -- Need M} |

-- TAG-MBSConfigure-STOP
-- ASN1STOP

RRCResume-IEs field descriptions

radioBearerConfig
Configuration of Radio Bearer (MRB) including SDAP/PDCP.

### 5.3.X Multicast Reception Request Procedure

### 5.3.X.1 General

### Figure 5.3.X. 1-1 Multicast Reception Request

The purpose of this procedure is to setup multicast reception request in RRC_INACTIVE state, including multicast MRB(s).

### 5.3.X.2 Initiation

The UE initiates the procedure when upper layers or AS (when responding to RAN paging) requests the reception of Multicast in RRC_INNACTIVE state.

The UE shall ensure having valid and up to date essential system information as specified in clause 5.2.2.2 before initiating this procedure.

Upon initiation of the procedure, the UE shall:

1> if the resumption of the RRC connection is triggered by response to NG-RAN paging:
2> select ‘0’ as the Access Category;
2> perform the unified access control procedure as specified in 5.3.14 using the selected Access Category and one or more Access Identities provided by upper layers;
   3> if the access attempt is barred, the procedure ends;

### MBSReceptionRequest

The MBSReceptionRequest message is used to request the reception of multicast data in RRC_INACTIVE state.
Signalling radio bearer: SRB0
RLC-SAP: TM
Logical channel: CCCH
Direction: UE to Network
MBSReceptionRequest message

-- ASN1START
-- TAG-MBSRECEPTIONREQUEST-START

| | |
|---|---|
| MBSReceptionRequest ::= | SEQUENCE |
| { mbsReceptionRequest | MBSReceptionRequest-IEs} |
| MBSReceptionRequest-IEs ::= | SEQUENCE |
| { ueIdentity | ShortI-RNTI-Value, |
| ueMAC-I | BIT STRING (SIZE (16)), |
| multicastSessionId | MulticastSessionId, |
| spare | BIT STRING (SIZE (1))} |

-- TAG-MBSRECEPTIONREQUEST-STOP
-- ASN1STOP

MBSReceptionRequest -IEs field descriptions

```
  multicastSessionId
  Indicates which MBS session the reception is requested for
  ueIdentity
  UE identity to facilitate UE context retrieval at gNB.
  ueMAC-I
  Authentication token to facilitate UE authentication at gNB. The 16
least significant bits of the MAC-I calculated using the AS security
configuration as specified in 5.3.13.3.
```

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

The present invention provides a multicast pre-configuration information for the multicast session according to some aspects hereafter described.

In Release 17, the MBS multicast session follows state transitions as defined in 3GPP TS 23.247 v17.3.0, FIGS. 4.3-1. The session management procedures include session creation (7.1.1.2 or 7.1.1.3 of TS 23.247), session activation (7.2.5.2 of TS 23.247), session establishment and join (7.2.1.3 of TS 23.247). It is only when the MBS session is established that the network will configure the UE for the reception of multicast data.

The establishment of an MBS session in a UE is performed when the UE is in RRC_CONNECTED state. Then, the network may decide to switch the UE to RRC_INACTIVE state before the MBS multicast data are available through the session activation. When the session is activated the network will have to notify the UEs that have joined the session, and the network will have to switch the UEs that are in RRC_INACTIVE state to RRC_CONNECTED state to configure them.

As a first observation, the Release 17 specifications do not provide a procedure to configure a UE in RRC_INACTIVE state. A UE in RRC_INACTIVE state shall be resumed to RRC_CONNECTED state when an MBS session is activated.

Based on Release 17, at MBS session activation, all UEs belonging to the multicast group shall be configured at the same time.

As a second observation, for a large number of UEs, the delivery of MBS configuration at MBS multicast session activation may lead to link congestion and delay.

### MBS Pre-Configuration

To avoid a massive MBS configuration at MBS session activation, it is proposed to pre-configure the UEs before the MBS session activation.

MBS configuration may be delivered at different stages:
At MBS session establishment (or after) when the UE is in RRC_CONNECTED state,
When a UE is switched to RRC_INACTIVE state to provide PTM configuration to receive the multicast data in RRC_INACTIVE state,
When a UE is already in RRC_INACTIVE state, e.g., for PTM configuration update.

Then, at MBS multicast session activation, the UEs are notified by the network and they can apply the stored MBS configuration to start receiving the multicast data.

The UEs being pre-configured at different moments (before the session activation), the network load may be alleviated at the MBS session activation.

It is preferred that the network provides MBS multicast configuration to the UEs in the multicast group before MBS session activation for the UEs that can receive MBS multicast data in RRC_INACTIVE state, the network may provide the PTM configuration(s) for some cells (e.g., neighbour cells) or for all cells in the MBS service area. The advantage for a UE in RRC_INACTIVE state receiving MBS multicast data is to be able to switch to a new cell without notifying the network to request a configuration. After performing the cell re-selection process and switching to a new cell, the UE can apply the stored PTM configuration corresponding to the new cell.

It is proposed that when a UE can receive MBS multicast data in RRC_INACTIVE state, the network may provide to the UE the PTM configuration(s) for several cells in the neighbourhood.

### Notification of MBS Session Activation

At MBS session activation, the network may perform group paging indicating the activation of an MBS multicast session. A UE in RRC_INACTIVE state that has been pre-configured may directly apply the stored PTM configuration without notification to the network.

The UE may however notify the network to indicate its presence. For this purpose, the UE may send a RRC Resume Request message and the network may respond with a RRC Release with suspendConfig message to maintain the UE in RRC_INACTIVE state. Besides, this notification from UEs enables a gNB to estimate the number of UEs effectively receiving in RRC_INACTIVE state.

As an alternative method to group paging, the network may indicate the activation of MBS session activation through SIB.

It is proposed that UEs in RRC_INACTIVE state may receive the notification of MBS session activation through group paging or SIB

It can be noted that whether the multicast session can be received in RRC_INACTIVE state is implicitly indicated to the UE by receiving from the network a PTM configuration applicable in RRC_INACTIVE state. The explicit indication whether multicast can be received in RRC_INACTIVE state through paging may not be necessary.

### PTM Configuration Delivery in RRC_INACTIVE State

Two options are considered for PTM configuration delivery in RRC_INACTIVE state: using a dedicated signalling or based on SIB plus MCCH. However, providing PTM configurations using MCCH channel presents some drawbacks related to security (about the authorization to receive the multicast data). Furthermore, the MCCH content may be transmitted periodically and thus, it is not efficient in terms of bandwidth.

It is proposed that PTM configuration should be provided to a UE in RRC_INACTIVE state via a dedicated RRC signalling.

When a UE is switched to RRC_INACTIVE state, the network may provide PTM configuration through the RRC Release with SuspendConfig message. Such PTM configuration delivery can be performed before MBS session activation (i.e., pre-configuration) or after MBS session activation. This message may include the PTM configuration for one or several cells in the MBS service area.

The process shown in FIG. 8 illustrates the PTM configuration delivery when switching to RRC_INACTIVE state.

After MBS session establishment, the gNB may decide to switch a UE to RRC_INACTIVE state (it may be decided with assistance information from the core network). At this stage, the gNB may decide to pre-configure the UE to be able to receive the multicast data while in RRC_INACTIVE state, by sending a RRCRelease message with SuspendConfig including the suitable PTM configuration. The UE is then aware that it is enabled to receive multicast data in RRC_INACTIVE state

In the same way, when the network has to configure a UE already in RRC_INACTIVE state, the RRC Release with SuspendConfig message may also be used to provide PTM configuration(s) while maintaining the UE in RRC_INACTIVE state. This may concern the following cases:
1) when the configuration is triggered by the UE, e.g., at cell re-selection when the UE is receiving multicast data and does not have the PTM configuration for a target cell,
2) when the configuration is at the initiative of the network.

In the first case (configuration triggered by the UE), the UE may send a RRC Resume request to the network (before or after cell switching) indicating the need for one or several PTM configuration(s) for a given MBS multicast session. Then, the network may respond with the RRC Release with SuspendConfig message including the requested PTM configuration(s). In the second case (initiated by the network), the network may perform group paging announcing the availability of PTM configuration(s) for an MBS multicast session. Then, a UE interested in the MBS session may send a RRC Resume Request message to notify its presence and its interest in the MBS session. Finally, the network may send a RRC Release with SuspendConfig message including PTM configuration(s). This procedure may be performed at any time, before or after the MBS session activation (e.g., for an update). It may also be performed at the MBS session activation, meaning that the group paging would contain both the notification of MBS session activation and the notification of PTM configuration.

As a proposal, PTM configuration(s) may be provided to a UE being switched to RRC_INACTIVE state or already in RRC_INACTIVE state using RRC Release with SuspendConfig message.

In both cases, the network may provide the PTM configuration(s) for some cells (e.g., neighbour cells) or for all cells in the MBS service area.

Also, in both cases, the UEs may be maintained in RRC_INACTIVE state (without switching to RRC_CONNECTED state).

It is proposed that a UE in RRC_INACTIVE state may receive PTM configuration(s) without being switched to RRC_CONNECTED state.

Before sending PTM configuration(s) to a UE, the network should check that the UE belongs to the multicast group (i.e., that it has joined the MBS session and is authorized to receive the multicast data).

As an alternative method to group paging, the network may indicate the activation of MBS session activation through SIB.

It is proposed that group paging or SIB may be used to notify UEs in RRC_INACTIVE state about the availability of PTM configuration(s).

1. A method at a User Equipment, UE, of a wireless communication system, the method comprising:
receiving, for a multicast session for which the UE has requested to join, multicast pre-configuration information for the multicast session; and
configuring the UE according to the multicast pre-configuration information to receive multicast data via the multicast session.

2. A method according to claim 1, further comprising sending a request to join a multicast session to a core network via a base station.

3. A method according to claim 1, wherein the multicast pre-configuration information is received from a base station.

4. A method according to claim 1, wherein the multicast pre-configuration information is included in at least one of a Radio Resource Control, RRC, message, a system information block, SIB, and an MBS Control Channel (MCCH) message.

5. A method according to claim 1, wherein the pre-configuration information includes at least one of:
radio bearer configuration information associated with low quality of service, QoS, transmission,
radio bearer configuration information associated with high quality of service, QoS, transmission,
an inactive reception indicator that indicates to a UE if it is enabled to receive multicast data in a non-connected RRC state,
information identifying a group of UEs within the same cell interested in receiving multicast data,
a multicast pre-configuration ID identifying a configuration applied by UEs and associated with a multicast session ID,
discontinuous reception, DRX, configuration information,
neighbour cell multicast configuration information, and
cell identification information for identifying one or more cells for which the pre-configuration shall be applied.

6. A method according to claim 1,
wherein the multicast pre-configuration information comprises an update of existing configuration information for receiving multicast data via the multicast session, and
wherein the configuring comprises using the pre-configuration information to update the configuration of the UE to receive the multicast data via the multicast session.

7. A method according to claim 1, further comprising receiving data for the multicast session after performing the configuration according to the multicast pre-configuration information.

8. A method according to claim 1, wherein the multicast pre-configuration information is received prior to activation of the multicast session, optionally wherein the multicast pre-configuration information is received upon or after establishment of the multicast session.

9. (canceled)

10. A method according to claim 8, further comprising receiving a notification of activation of the multicast session after receiving the multicast pre-configuration information, optionally wherein the UE is configured according to the multicast pre-configuration information in response to receiving the notification.

11. (canceled)

12. A method according to claim 10, wherein said notification of activation is any one of a paging message, an RRC message, a system information block, SIB, and an MBS Control Chanel (MCCH) message.

13-15. (canceled)

16. A method according to claim 1, wherein the multicast pre-configuration information is received after the activation of the multicast session.

17-28. (canceled)

29. A method at a base station controlling a cell serving User Equipment, UE, the method comprising:
performing establishment of a multicast session requested by a UE; and
sending, to the UE, multicast pre-configuration information for the multicast session.

30. A method according to claim 29, comprising receiving a request to join the multicast session from the UE and sending the request to join the multicast session to a core network.

31. A method according to claim 29, wherein the multicast session is established between the UE, the base station and a core network.

32. A method according to claim 29, wherein the multicast pre-configuration information is included in at least one of a Radio Resource Control, RRC, message and a system information block, SIB.

33. (canceled)

34. A method according to claim 29, wherein the multicast pre-configuration information includes an update of existing configuration information for receiving multicast data via the multicast session.

35. A method according to claim 29, further comprising sending data for the multicast session to the UE, according to the multicast pre-configuration information.

36. A method according to any claim 29, where the multicast pre-configuration information is sent prior to activation of the multicast session, or after the activation of the multicast session, optionally wherein the multicast pre-configuration information is sent upon or after establishment of the multicast session.

37. (canceled)

38. A method according to claim 36, further comprising sending a notification of the activation of the multicast session to the UE, optionally wherein said notification of activation comprises at least one of a paging message, an RRC message and an SIB.

39-76. (canceled)

77. A computer-readable medium storing instructions which, when executed by a computer, cause the computer to carry out a method according to claim 1.

78. (canceled)
